(19) United States
(12) Patent Application Publication
(10) Pub. No.: US 2007/0271126 A1
(43) Pub. Date: Nov. 22, 2007

(54) System and method for formulating and managing corporate strategy

(75) Inventor: Janet Marie Hunter, Cammeray (AU)

Correspondence Address: William R. Evans;Ladas & Parry LLP, 26 West 61 Street, New York, NY, 10023, US

(73) Assignee: ETVIA CORPORATION PTY LTD

(21) Appl. No.: 11/796,743

(22) Filed: Apr. 27, 2007

(30) Foreign Application Priority Data
Apr. 27, 2006 (AU) 2006902189

(51) Int. Cl. G06F 17/50

(52) U.S. Cl. 705/7

(57) ABSTRACT

Disclosed is a method (200) for formulating and updating a strategy for an organisation using a computer management platform (700) running a computer program (726) comprising a data entry module, a presentation module, and a formulation and updating (FU) procedure module. The method comprises the steps of formulating (201) the strategy using the FU procedure module, publishing (204) the strategy comprising information about strategic goals, owners, strategy elements, documents and performance metrics using the presentation module, reviewing the strategy using the FU procedure module and the presentation module, and updating the strategy using FU procedure module and the presentation module.

### COPYRIGHT NOTICE

This patent specification contains material that is subject to copyright protection. The copyright owner has no objection to the reproduction of this patent specification or related materials from associated patent office files for the purposes of review, but otherwise reserves all copyright whatsoever.

### FIELD OF THE INVENTION

The present invention relates generally to computer based support arrangements for corporations, and in particular, to arrangements for defining and managing corporate strategy.

### BACKGROUND

When organisations plan they typically create plans by Business Unit or Department. The typical process used by organisations is to set organisational goals and then create departmental or discrete business unit plans to implement them. This can result in ‘siloed’ behaviour, and often means that organisational effort is more aligned to the organisational structure rather than to an organisation's objectives.

In the planning process, basic desktop publishing tools are usually used to produce the documents that are then tracked manually via status reports. Execution is then managed by the organisation's leaders as they see fit, typically using tools such as email, checklists, meeting minutes, project plans and so on.

Furthermore, when status reports are provided regarding plan execution status, the recipients view is limited to the view of the author. The tools and methodologies currently available to organisations for planning are usually one-dimensional, i.e. they are represented by flat files for documentation, recording and communication purposes only. These do not of themselves constitute a medium through which implementation is either facilitated or tracked. Organisations typically create their strategic plans and business plans as two discrete plans where the linkages between two plans are left to senior teams or management to interpret.

### SUMMARY

It is an object of the present invention to substantially overcome, or at least ameliorate, one or more disadvantages of existing arrangements.

Disclosed are arrangements, referred to as distributed Corporate Performance Management (CPM) arrangements, which seek to address the above problems by (a) facilitating formulation, dissemination and management of corporate strategy on a computerised platform spanning the organisation, (b) enabling strategy elements to be decomposed, in an ongoing dynamic fashion, into constituent sub-elements at virtually any level of the organisation, unfettered by the formal organisational structure, and (c) providing transparency of formulation and performance status to all users of the platform.

The term “strategy element” encompasses elements such as strategic (3-5 year) goals, financial period goals (also referred to as areas of focus), plans, projects, business cases, discrete deliverables and continuous metrics (also referred to as measures). The disclosed distributed CPM arrangements provide, in one integrated tool set, plan development capability, plan implementation facilitation and reporting capability. The disclosed arrangements also provide a methodology to support use of the tool.

According to a first aspect of the present invention, there is provided a method of formulating and managing a strategy for an organisation, the method comprising the steps of:

formulating strategic goals, extending across a plurality of financial periods, for the organisation;

determining objectives for an upcoming financial period, said objectives being required for achieving that part of the goals associated with the upcoming financial period;

resolving each objective into at least one of discrete deliverables and continuous metrics, wherein:
a performance status of a discrete deliverable can be characterised by being one of completed and not completed; and
a performance status of a continuous metric can be characterised by being partially completed;

assigning an owner to each said discrete deliverable and continuous metric;

disseminating information about (a) the strategic goals, (b) the objectives, (c) the discrete deliverables and their associated performance status, and (d) the continuous metrics and their associated performance status across the organisation; and, in regard to each said discrete deliverable and continuous metric, performing one of:
producing, under control of the corresponding owner, said discrete deliverable and said continuous metric; and
applying, by said corresponding owner, the resolving, assigning and disseminating steps to said discrete deliverable or a said continuous metric.

According to another aspect of the present invention, there is provided an apparatus for implementing any one of the aforementioned methods.

According to another aspect of the present invention there is provided a computer program product including a computer readable medium having recorded thereon a computer program for implementing any one of the methods described above.

Other aspects of the invention are also disclosed.

### BRIEF DESCRIPTION OF THE DRAWINGS

One or more embodiments of the present invention will now be described with reference to the following drawings, in which:

FIG. 1 shows a flow chart of how corporate strategy is formulated, disseminated and managed according to the disclosed distributed CMP arrangements;

FIG. 2 depicts how strategy elements are approved, and approval status transparency is provided;

FIG. 3 shows how deliverable formulation is performed, and formulation status transparency is provided;

FIG. 4 shows how corporate strategy is formulated in the FIG. 1;

FIG. 5 shows how strategy management in FIG. 1 is performed;

FIG. 6 depicts the disclosed distributed CPM arrangement being applied across business units of a corporation;

FIG. 7 depicts graphical user interfaces used in the arrangement in FIG. 1;

FIG. 8 depicts how the disclosed distributed CPM arrangements produce associated reports and documentation;

FIG. 9 is a schematic block diagram of a general-purpose computer system upon which the disclosed distributed CPM arrangements can be practiced;

FIG. 10 shows a screen dump of a GUI displayed by the disclosed distributed CPM system directed to an organisational view of a strategy;

FIG. 11 shows a screen dump of a GUI displayed by the disclosed distributed CPM system directed to a personal view of a strategy; and

FIGS. 12A and 12B depicts characteristics of the disclosed distributed CPM arrangement from various perspectives.

### DETAILED DESCRIPTION INCLUDING BEST MODE

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined at least by by the appended claims.

Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the description which follows are explicitly or implicitly presented in terns of algorithms and symbolic representations of operations on data within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that the above and similar terms are to be associated with the appropriate physical quantities and are merely convenient labels applied to these quantities. Unless specifically stated otherwise, and as apparent from the following, it will be appreciated that throughout the present specification, discussions utilizing terms such as “determining”, “outputting”, or the like, refer to the action and processes of a computer system, or similar electronic device, that manipulates and transforms data represented as physical (electronic) quantities within the registers and memories of the computer system into other data similarly represented as physical quantities within the computer system memories or registers or other such information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present invention also implicitly discloses a computer program, in that it would be apparent to the person skilled in the art that the individual steps of the preferred method described herein are to be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing the spirit or scope of the invention. Furthermore one or more of the steps of the computer program may be performed in parallel rather than sequentially.

Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

Where reference is made in any one or more of the accompanying drawings to steps and/or features, which have the same reference numerals, those steps and/or features have for the purposes of this description the same function(s) or operation(s), unless the contrary intention appears.

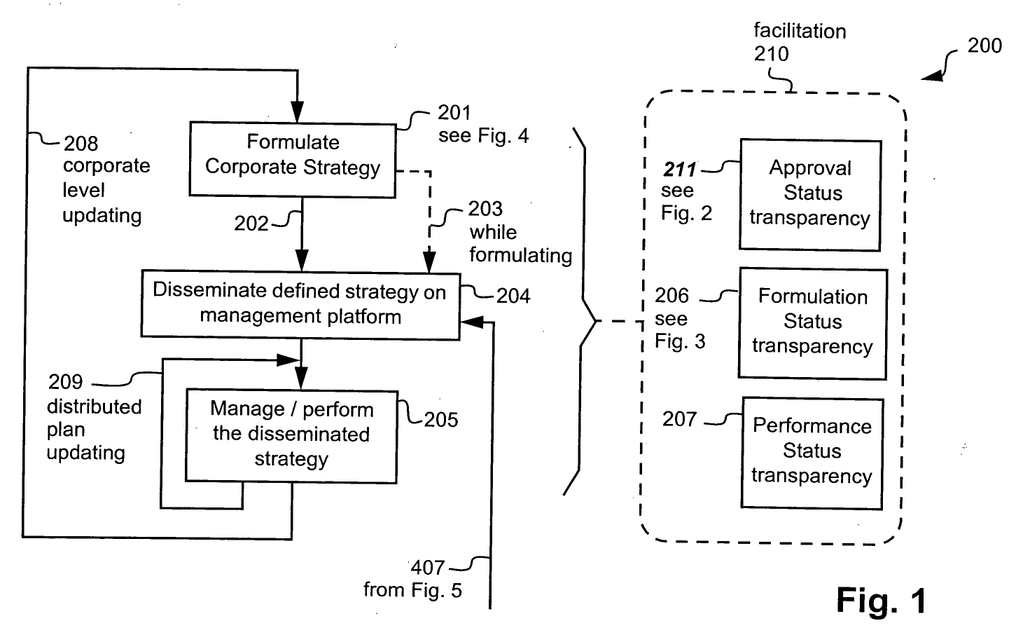

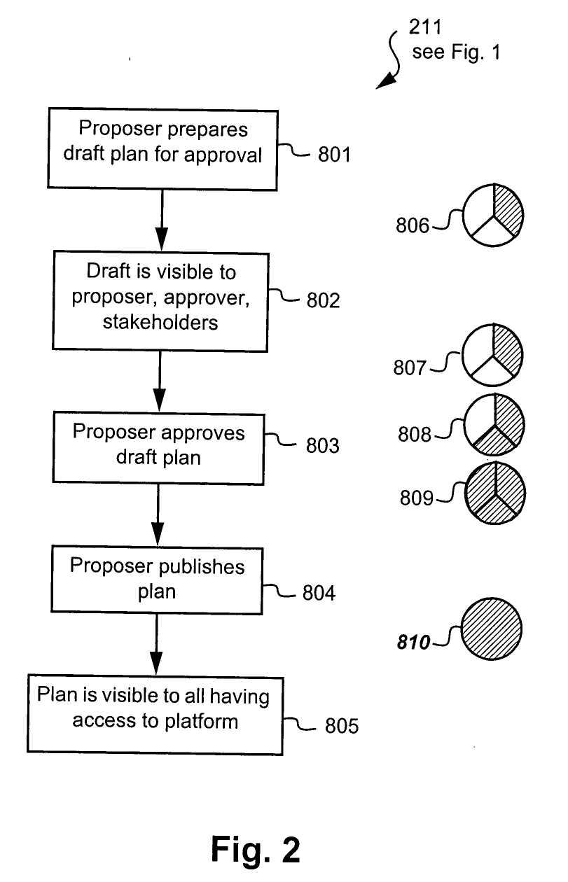

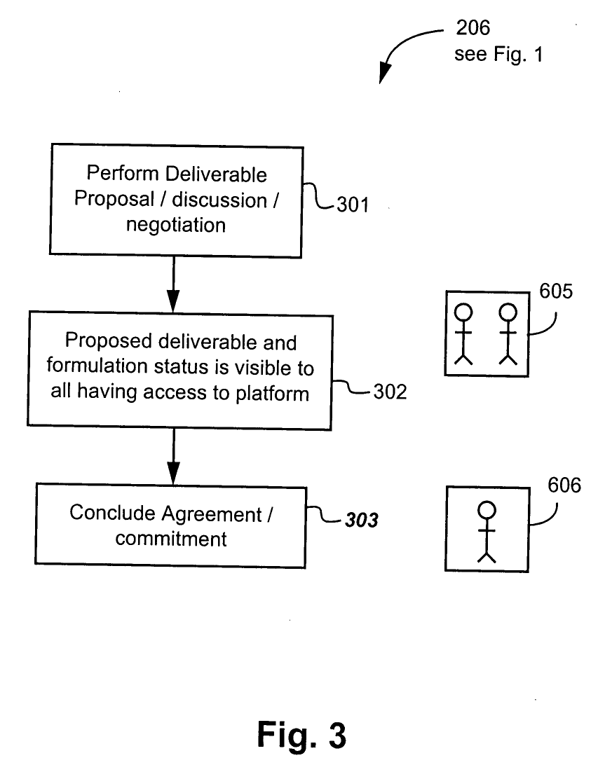

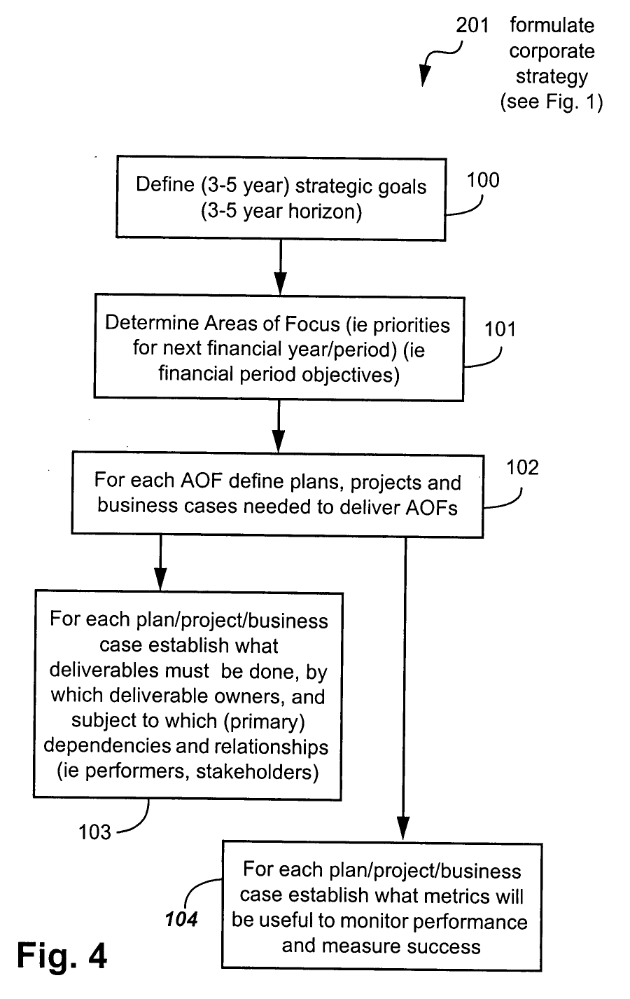

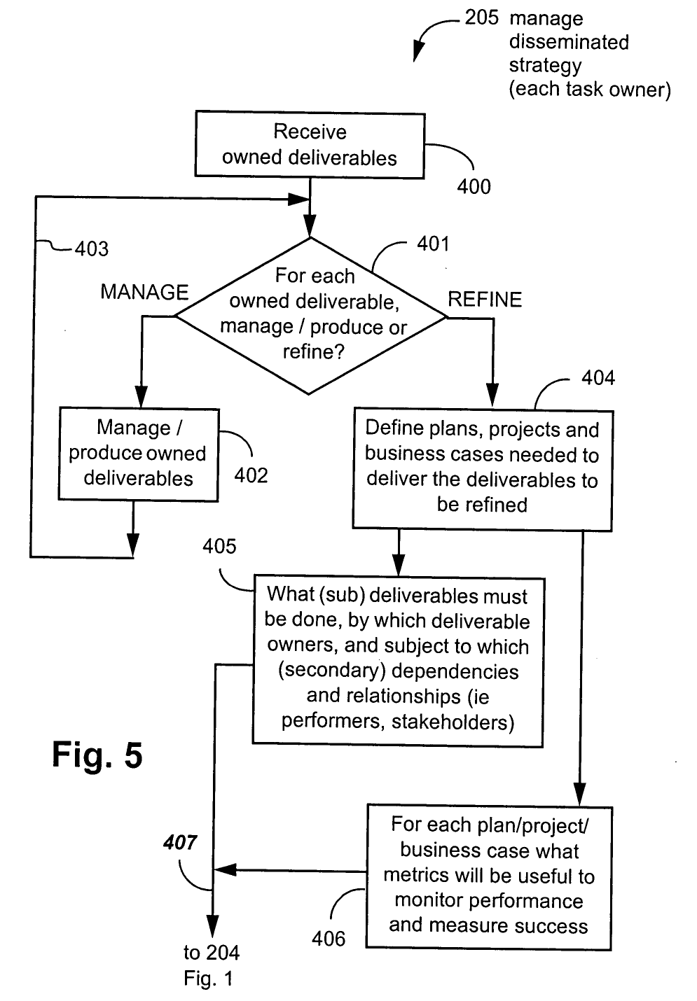

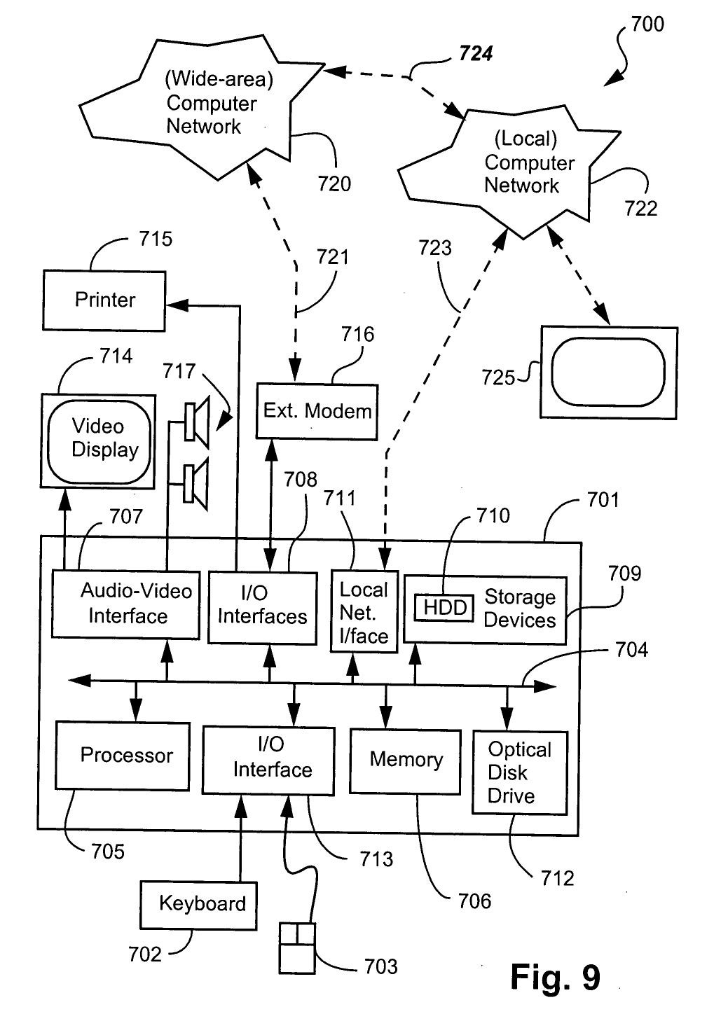

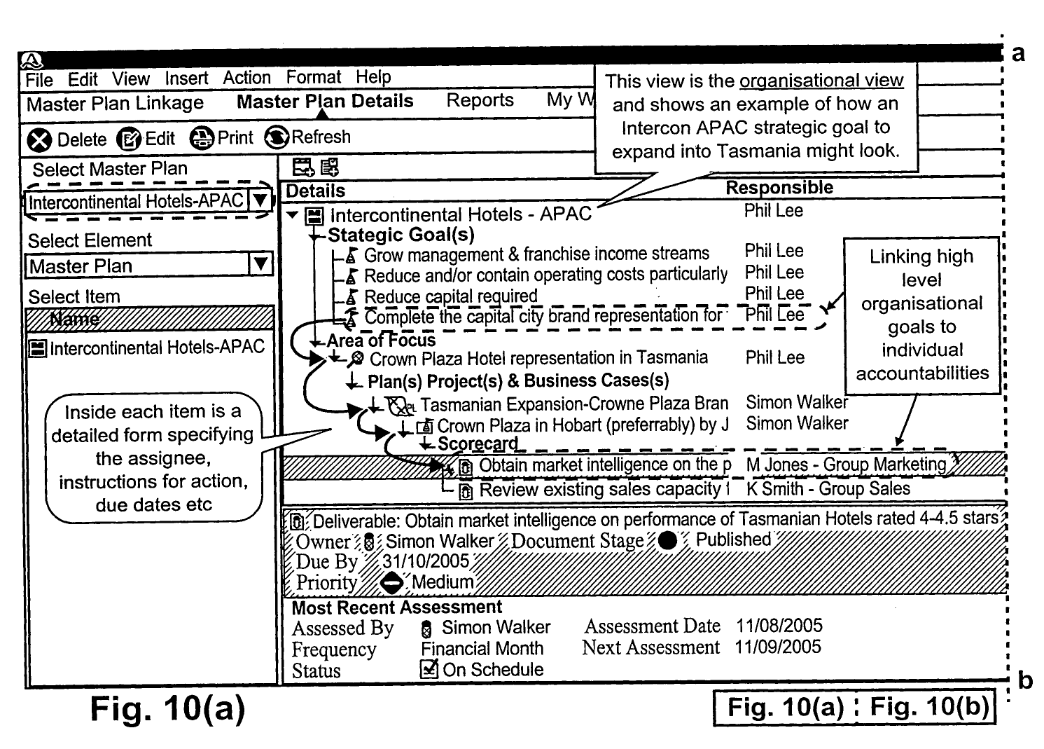

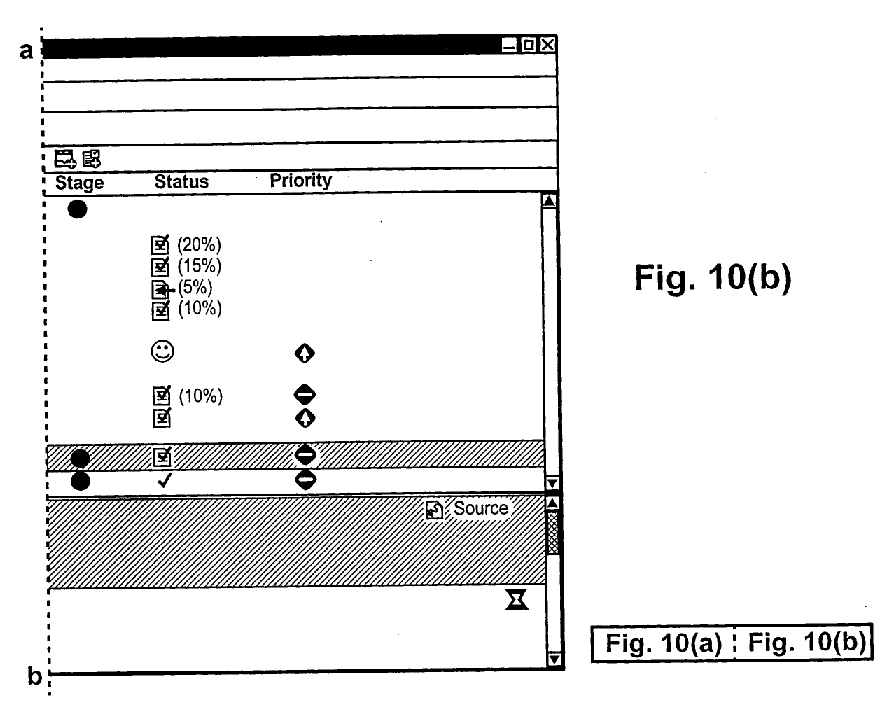

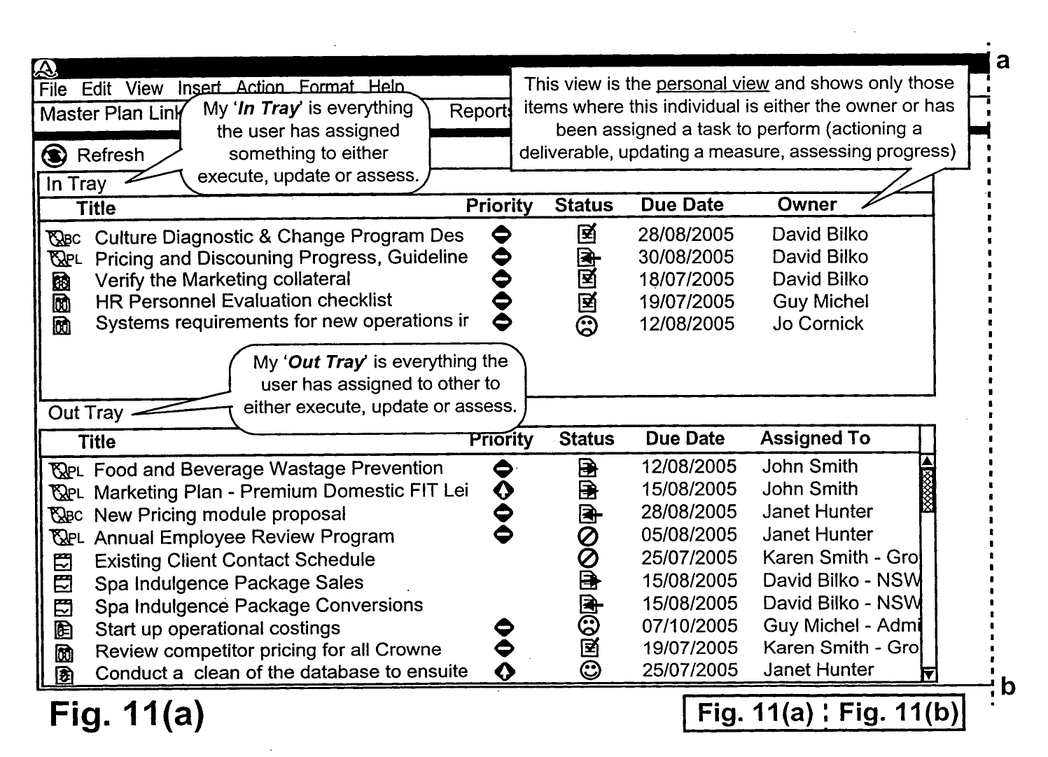

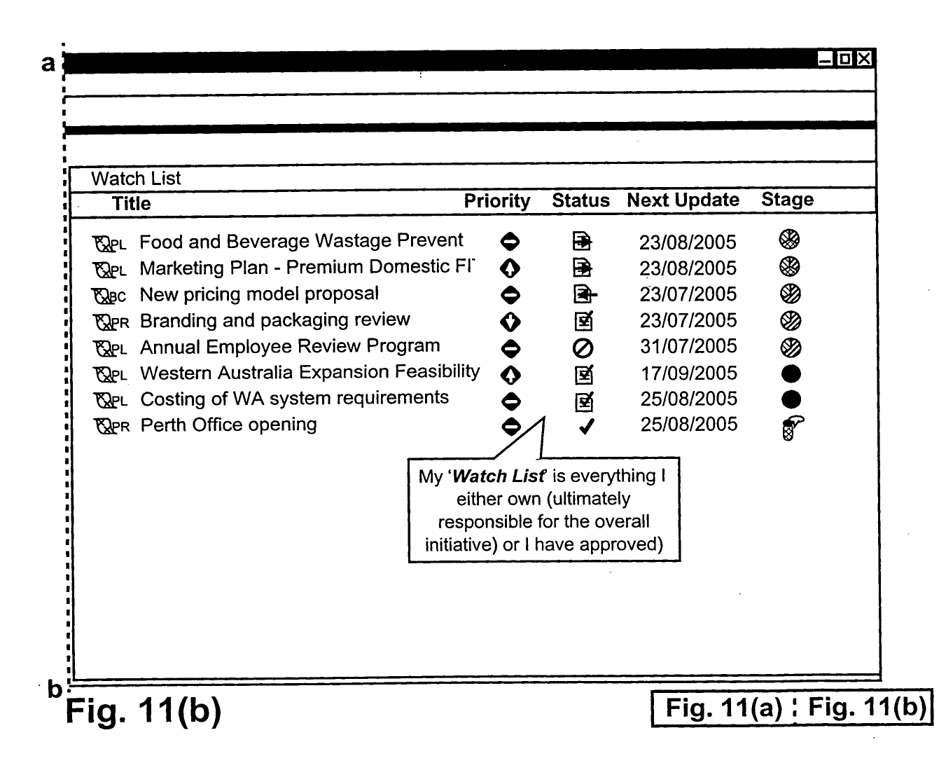

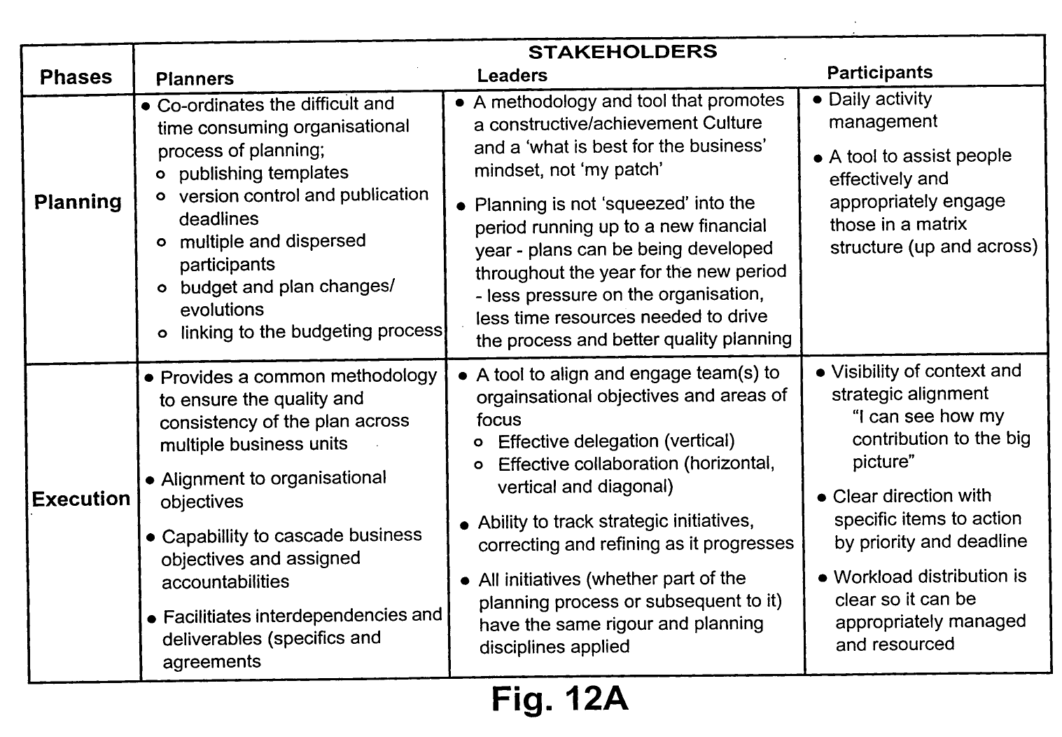

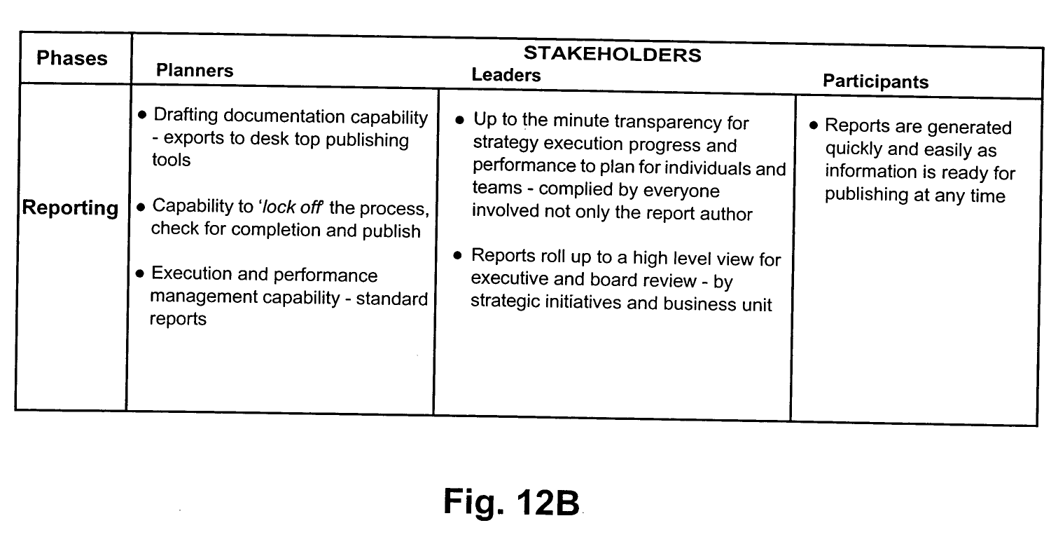

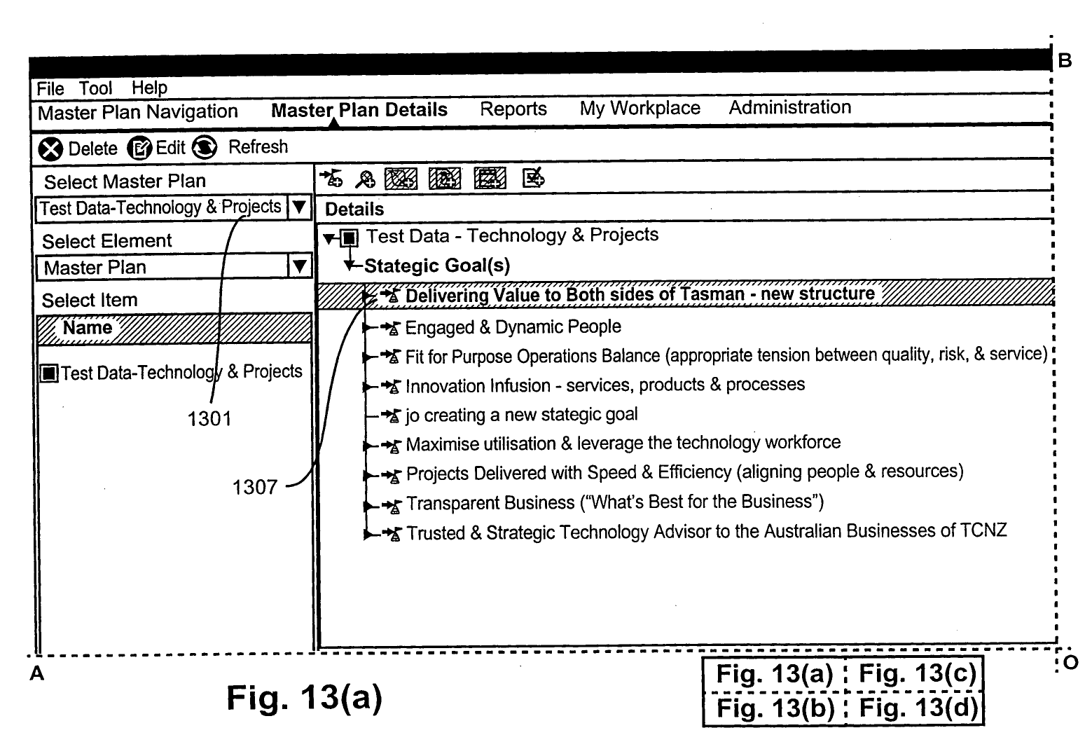

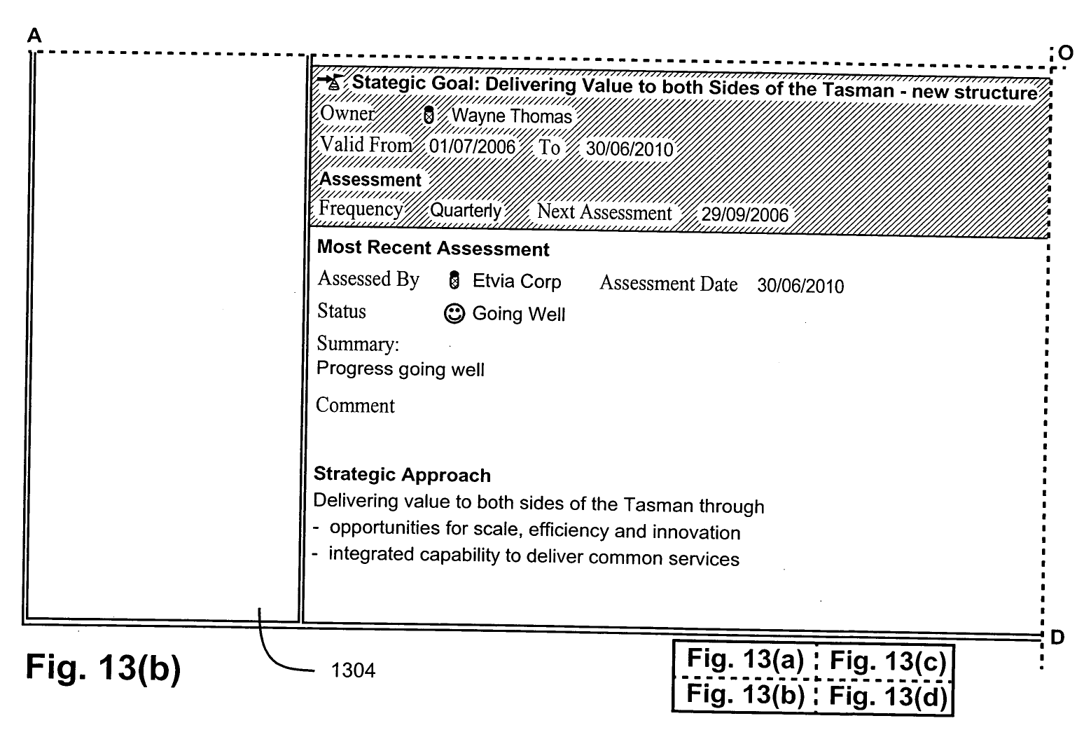

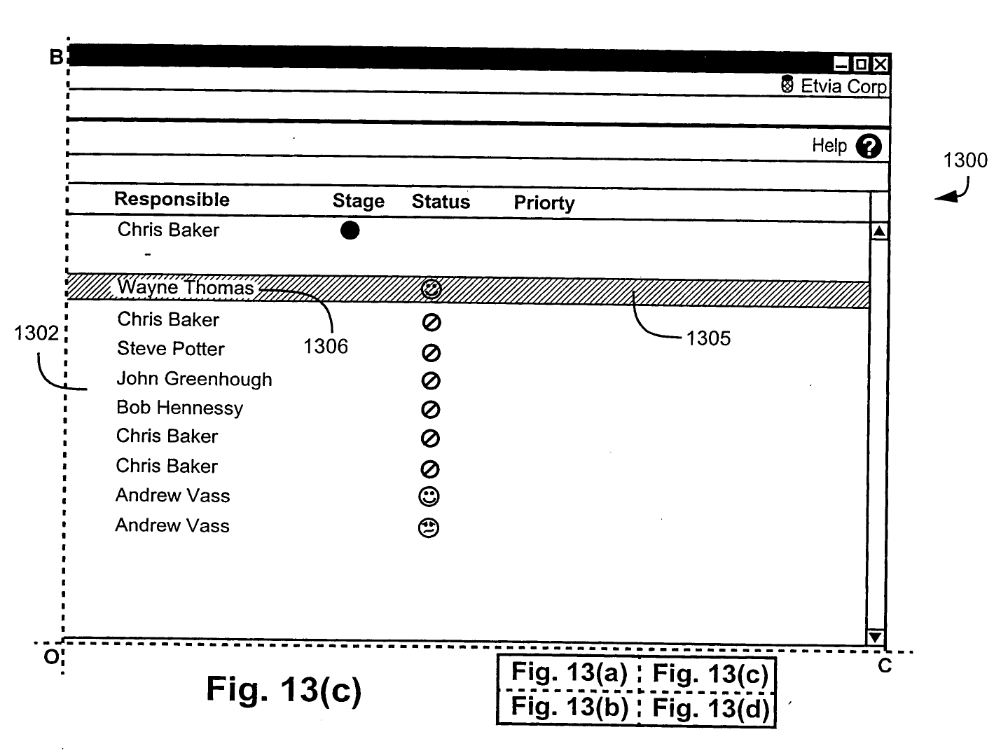

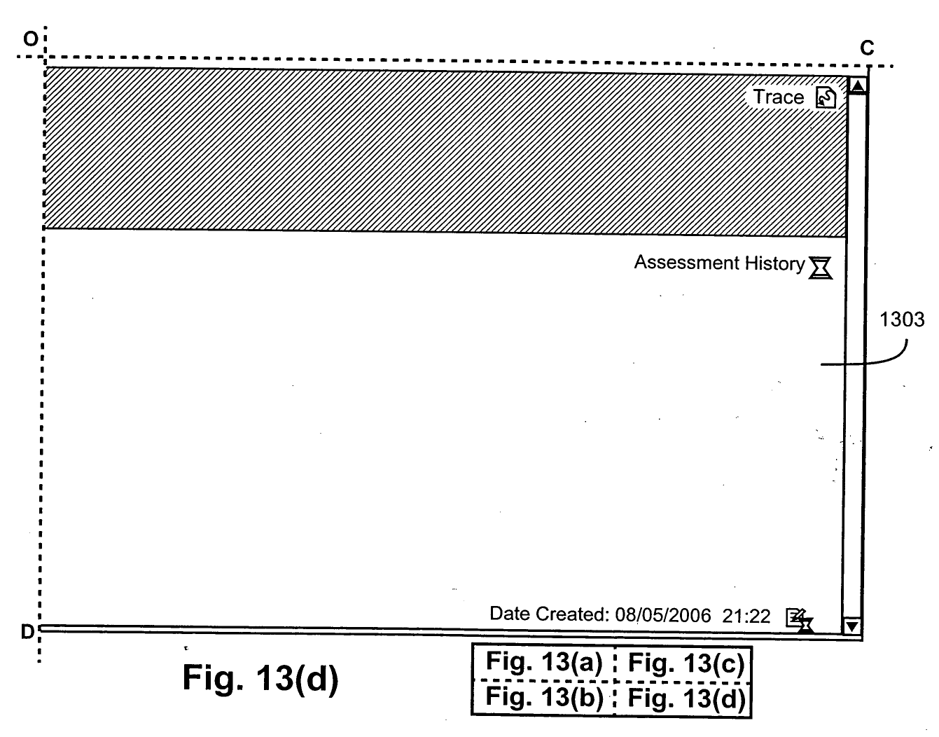

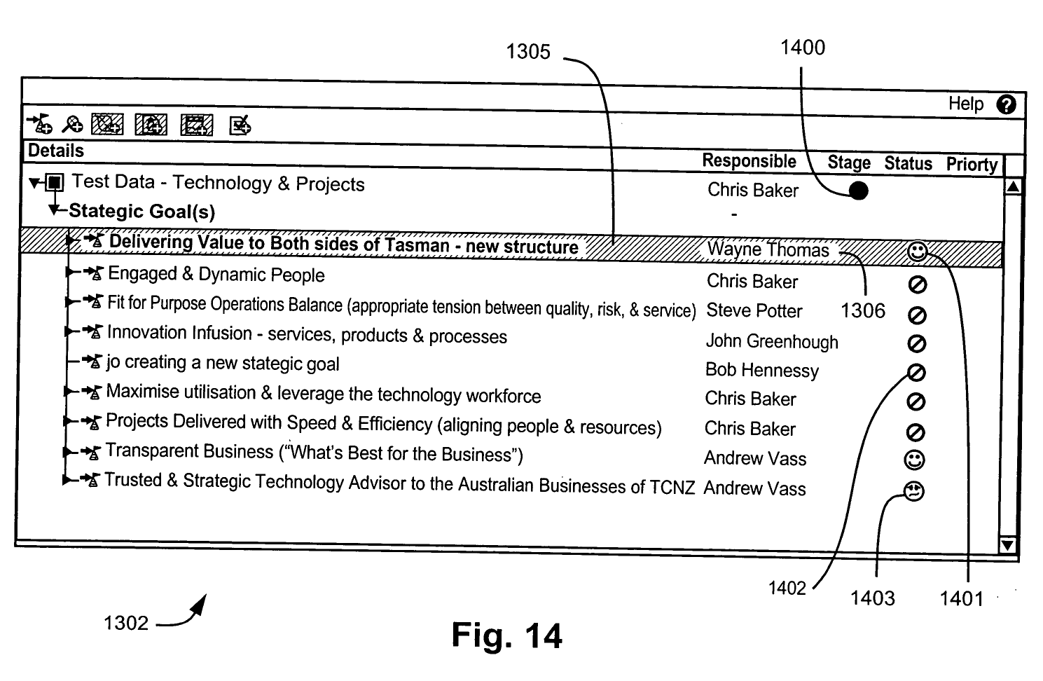

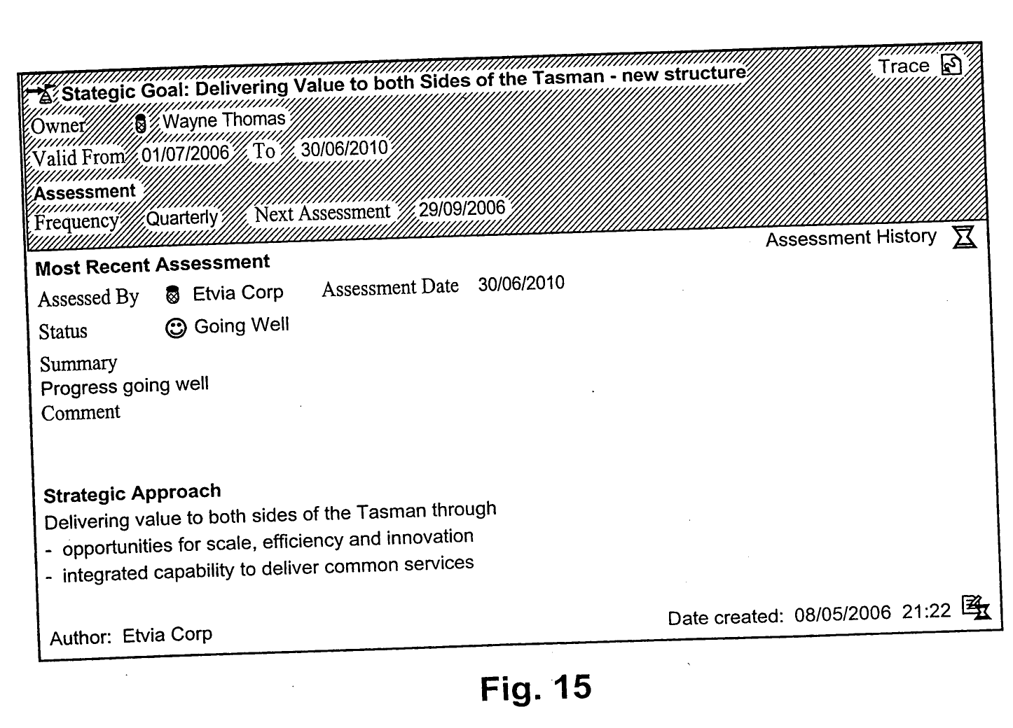

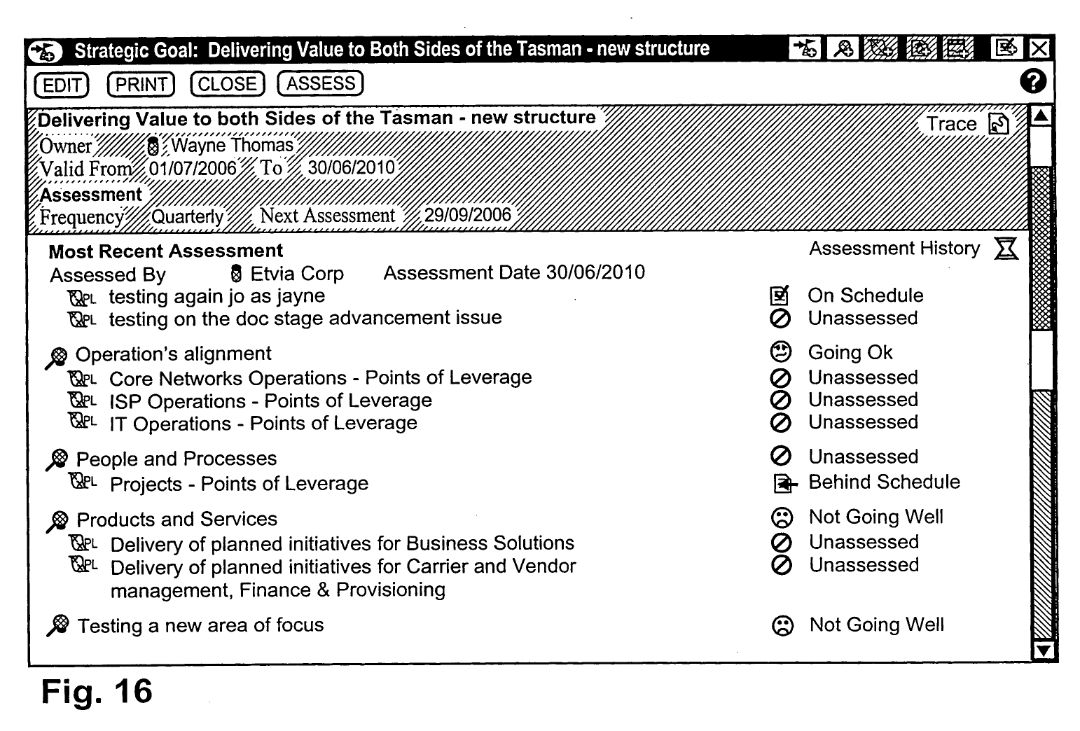

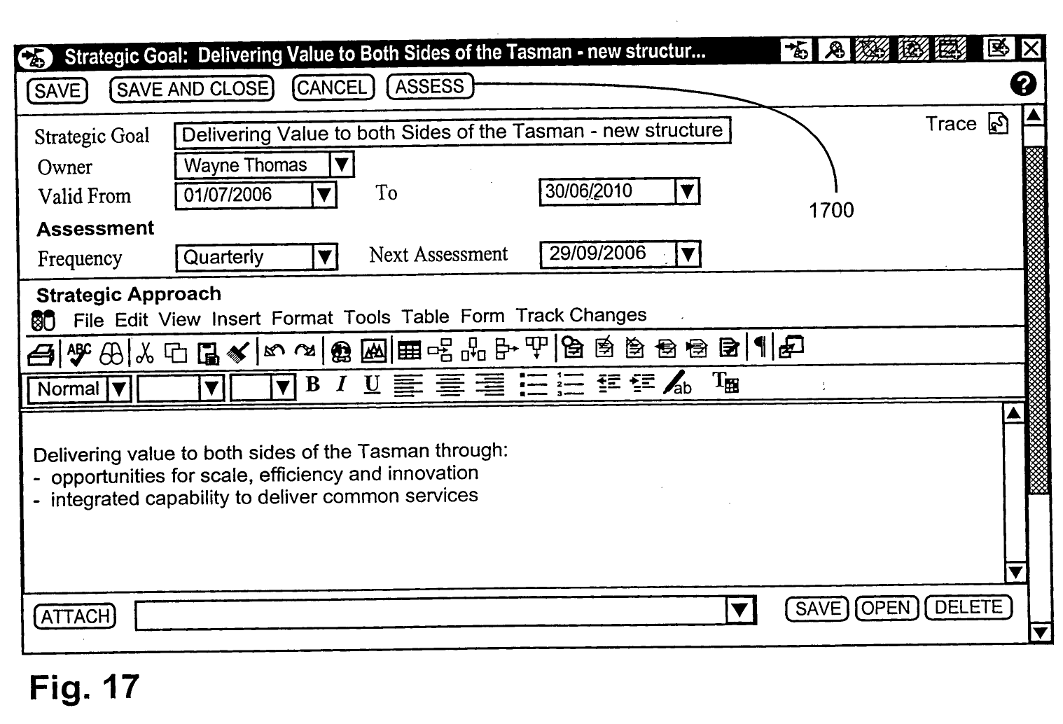

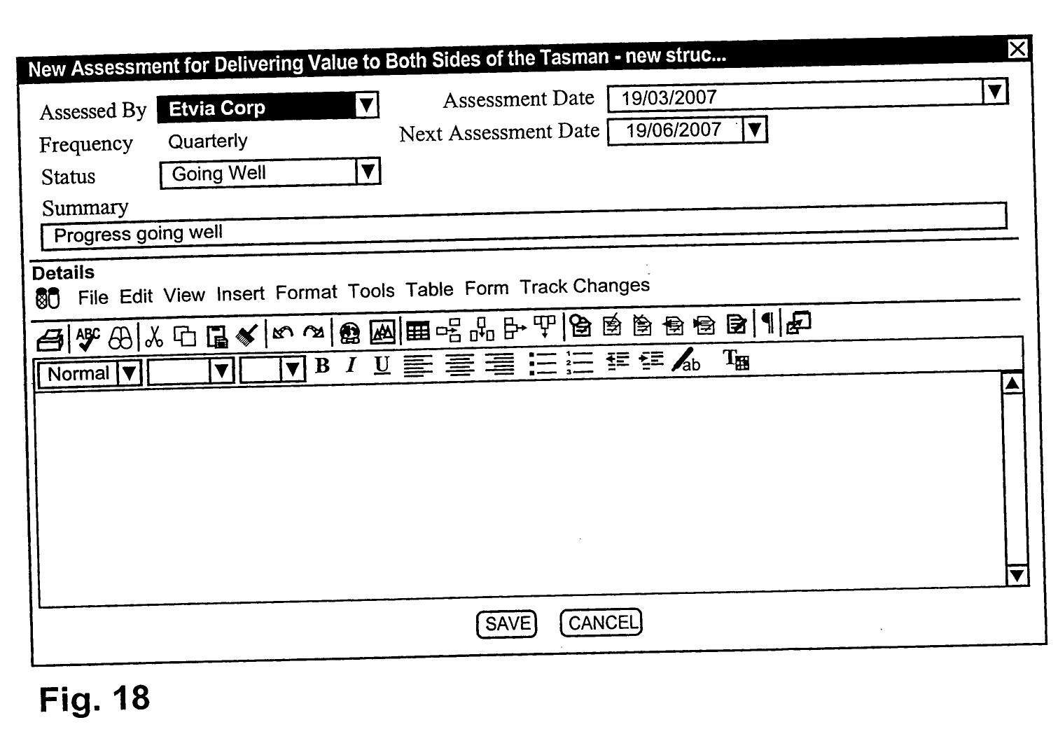

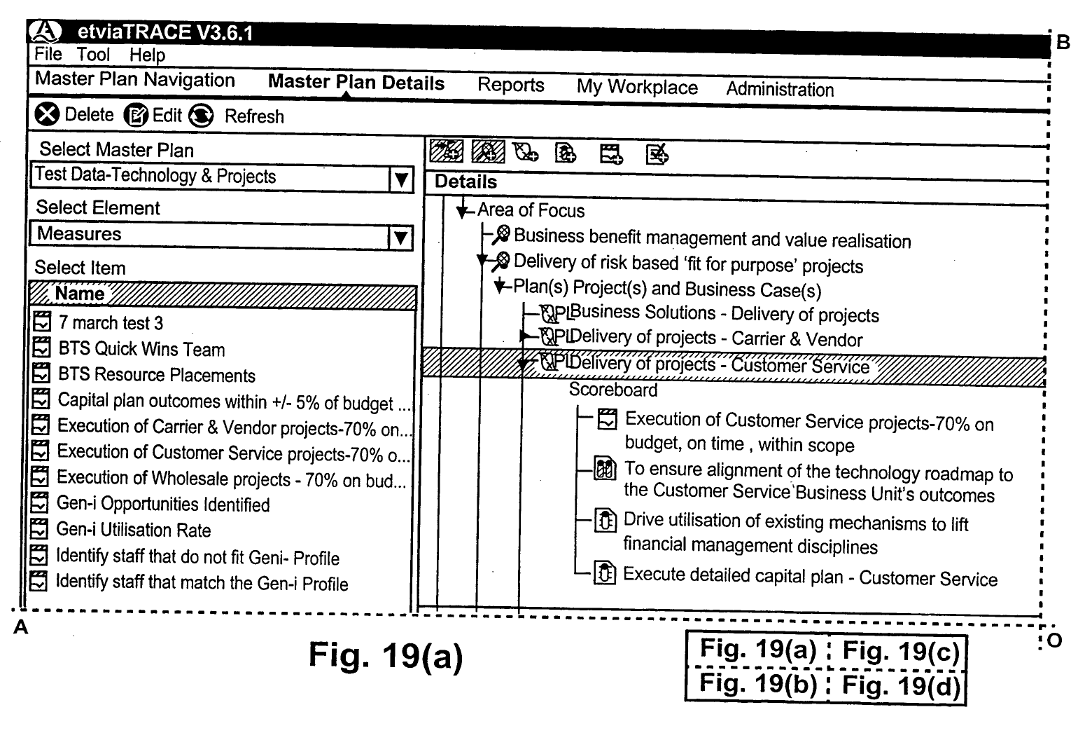

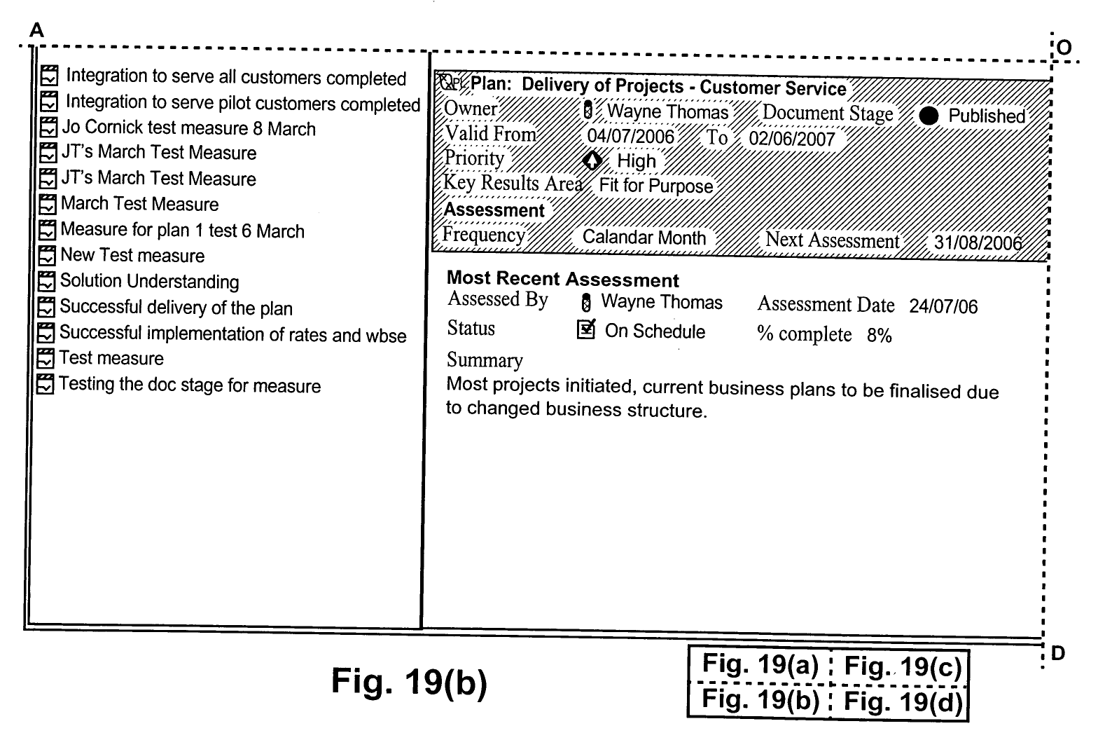

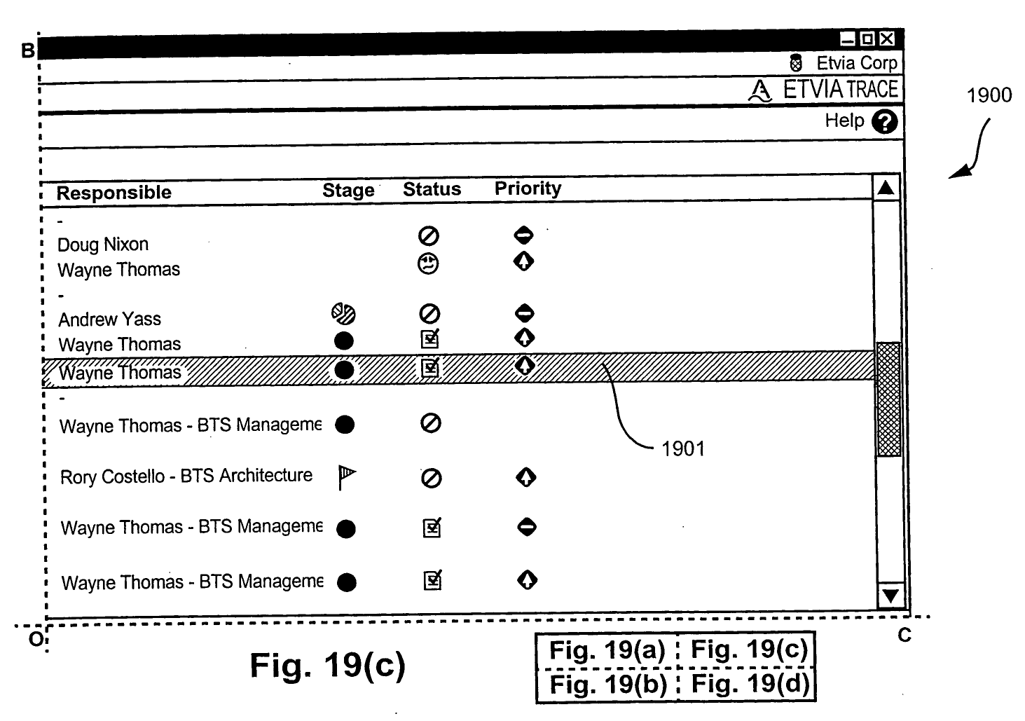

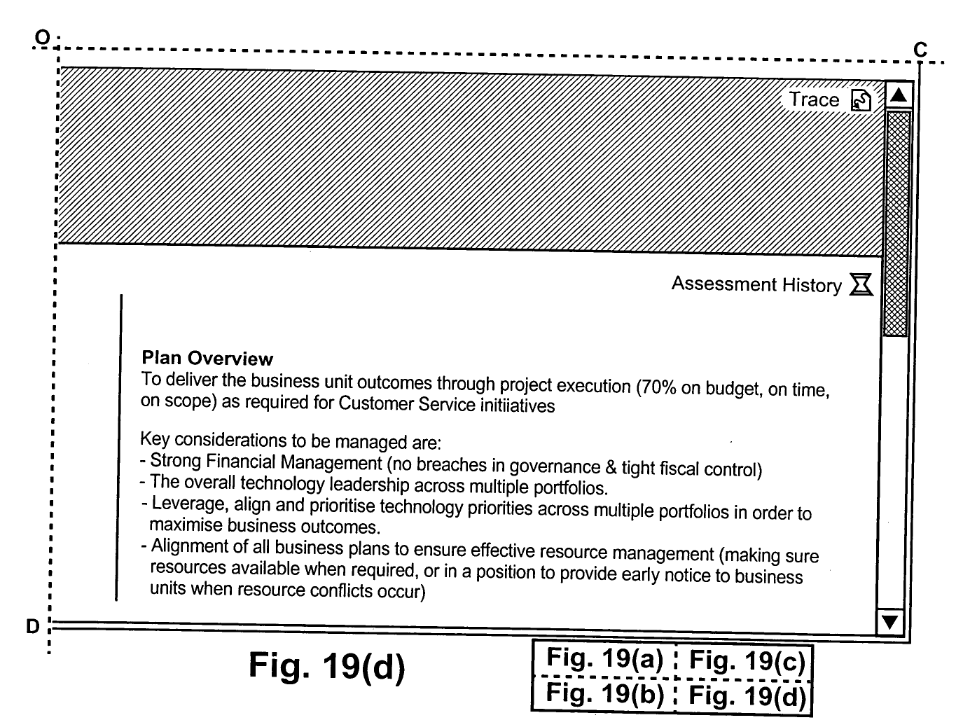

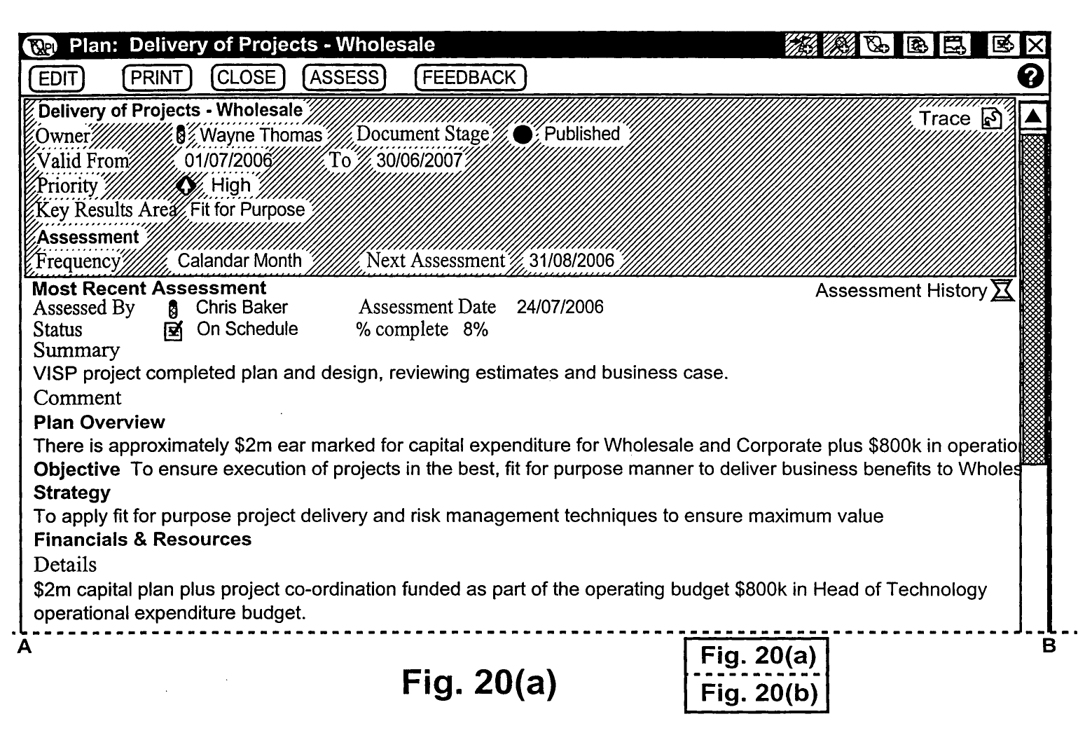

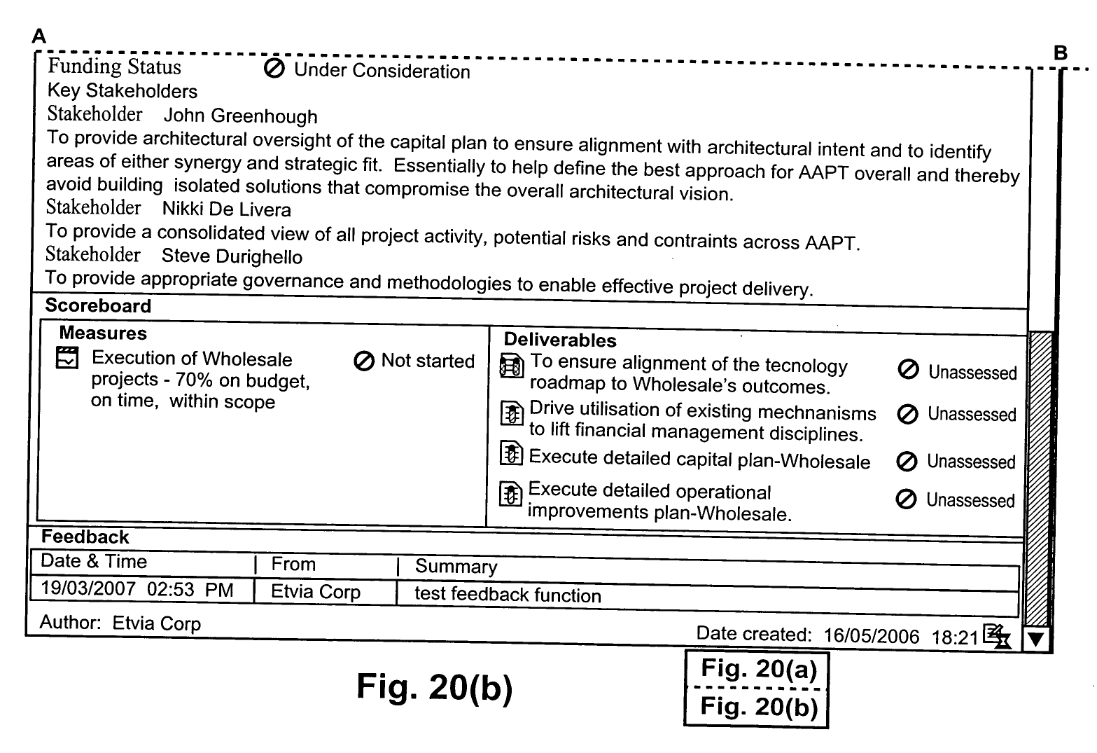

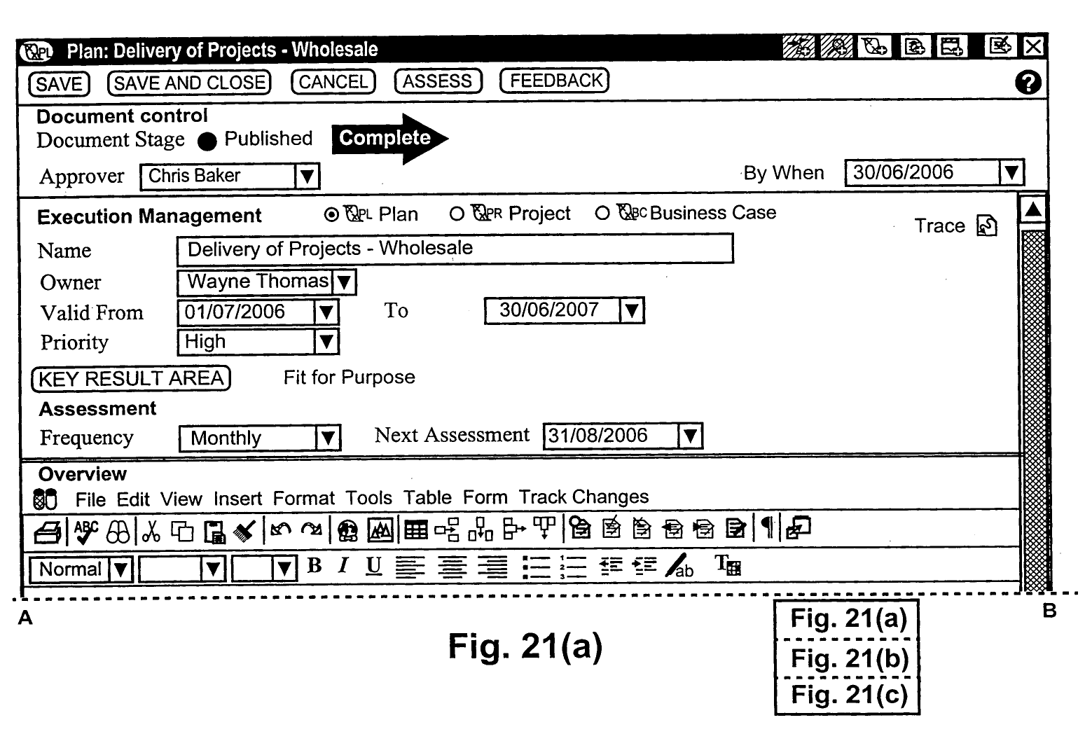

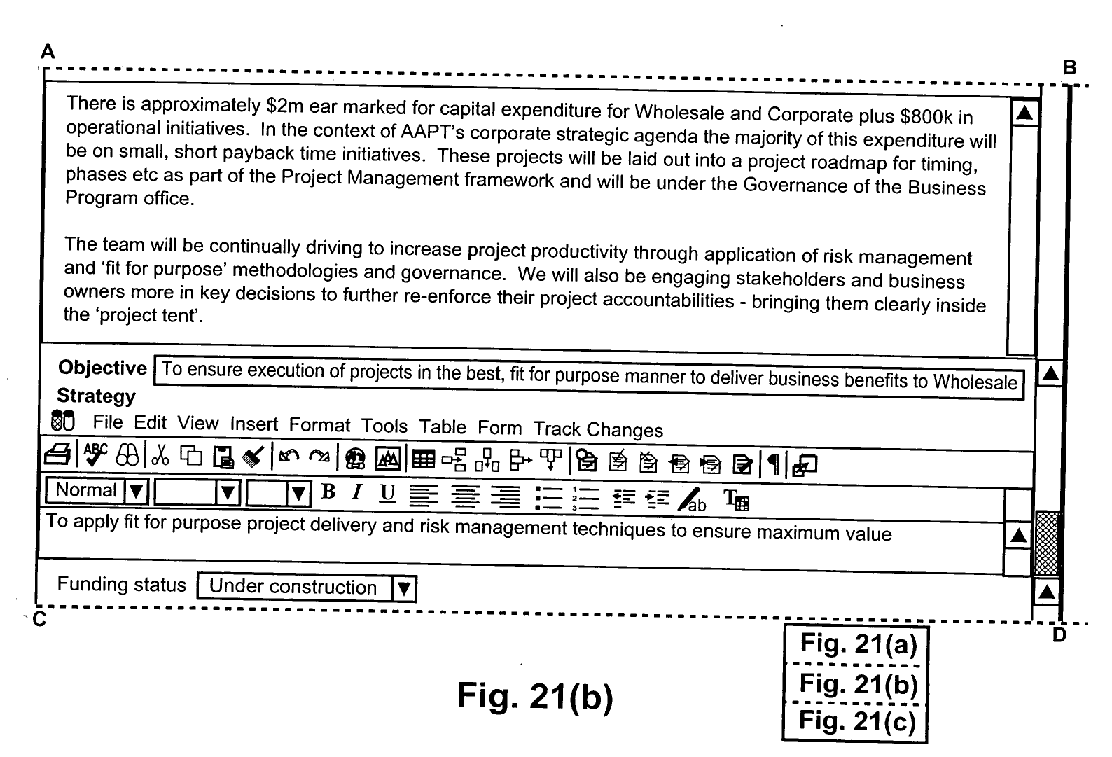

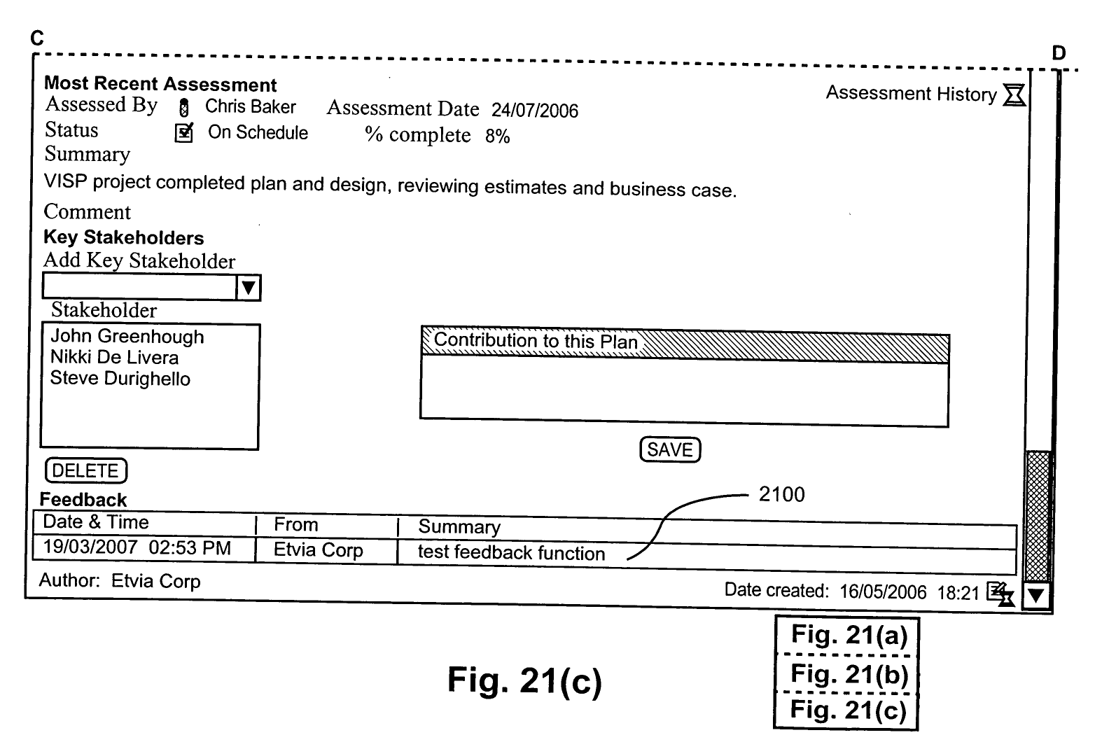

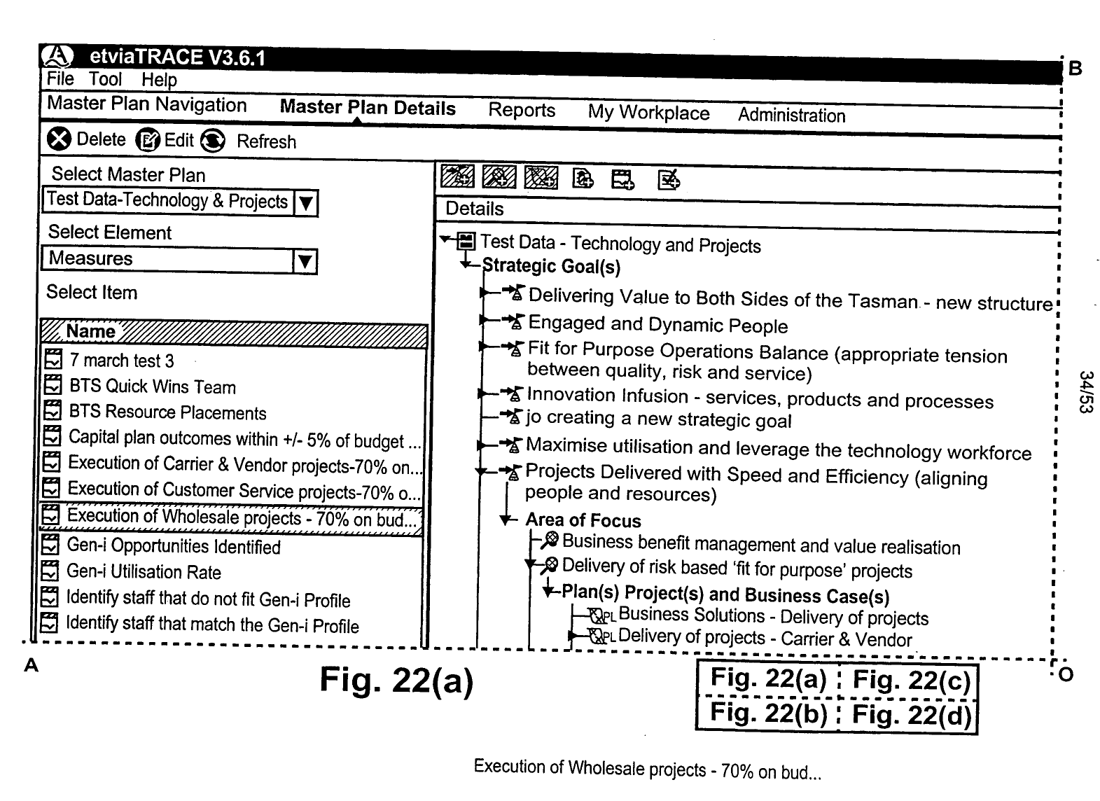

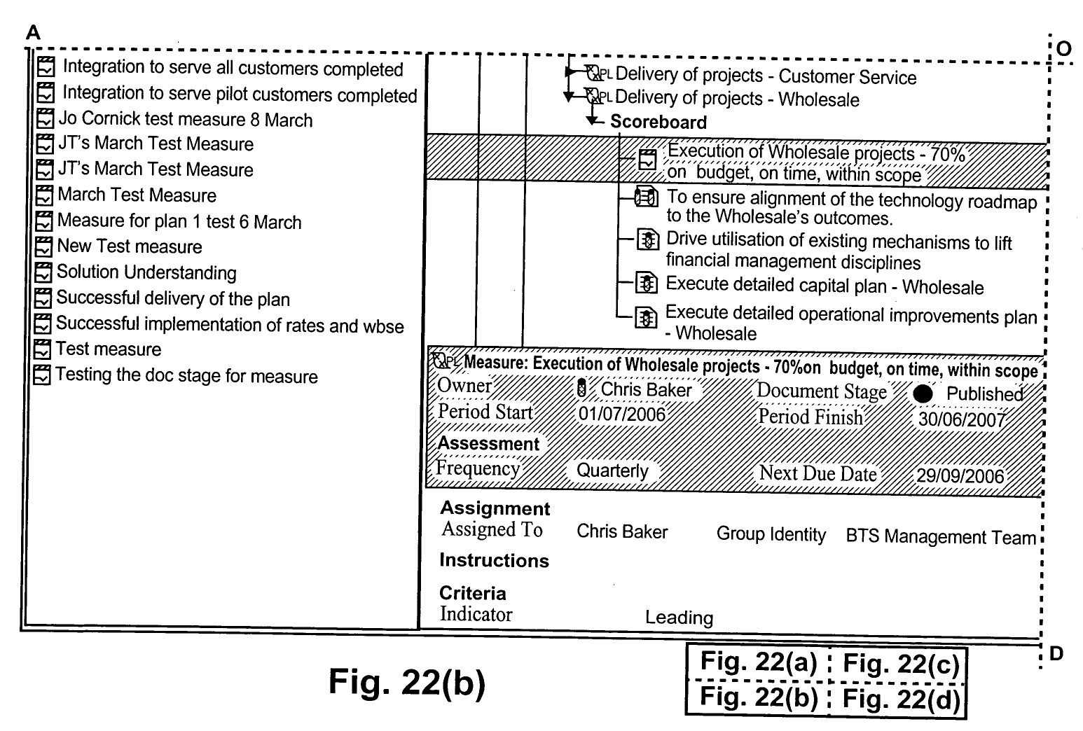

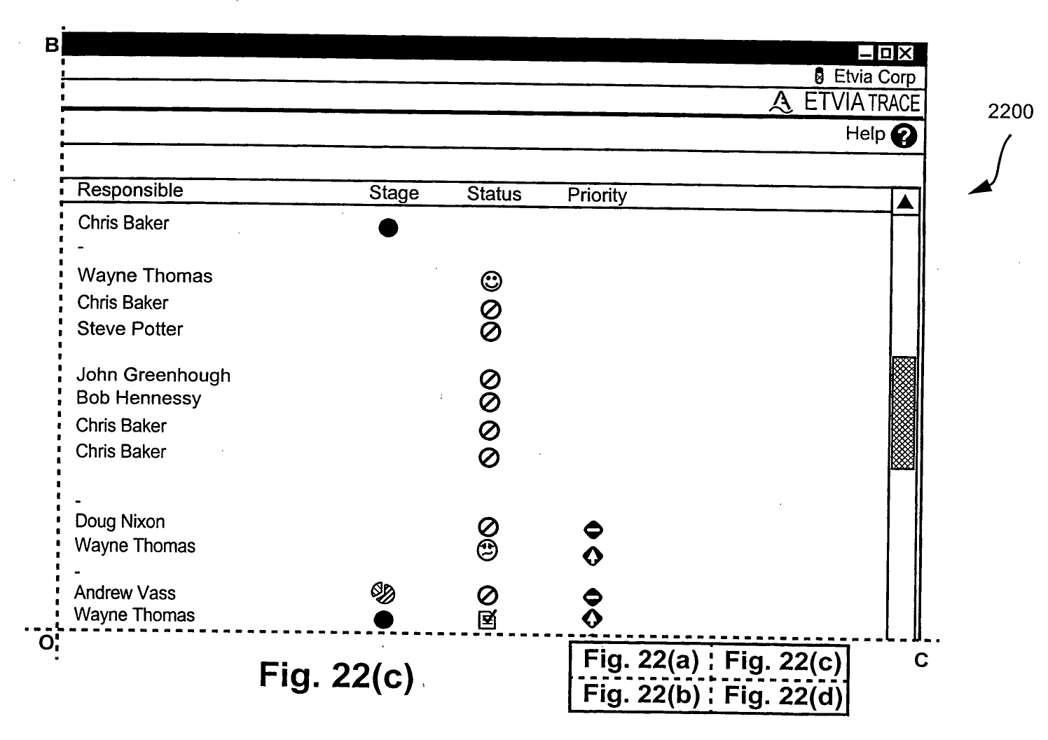

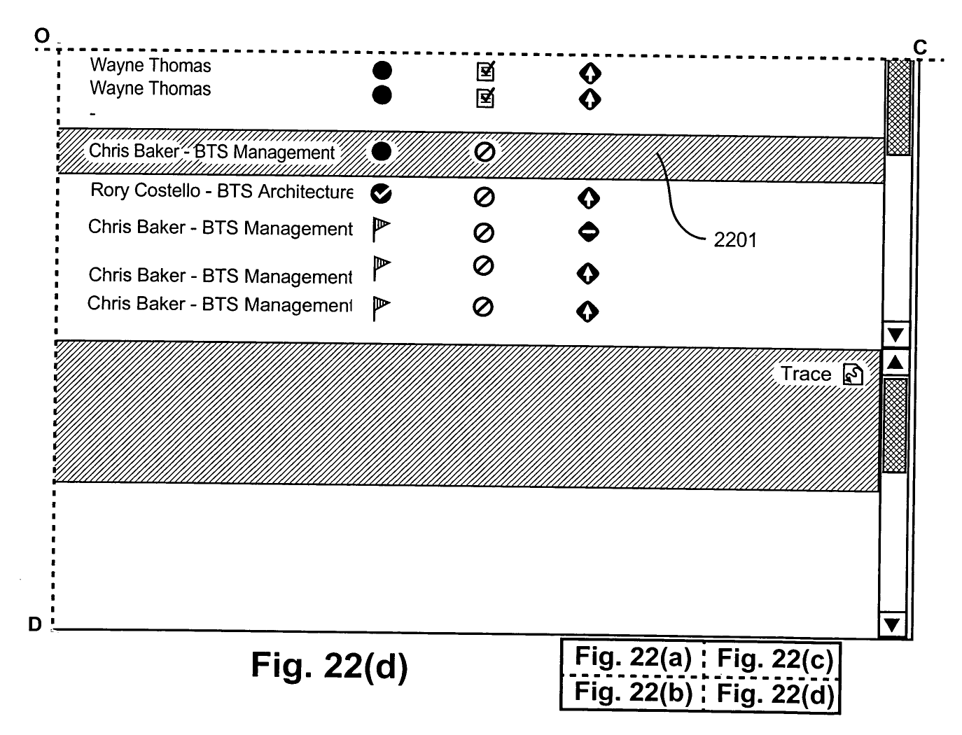

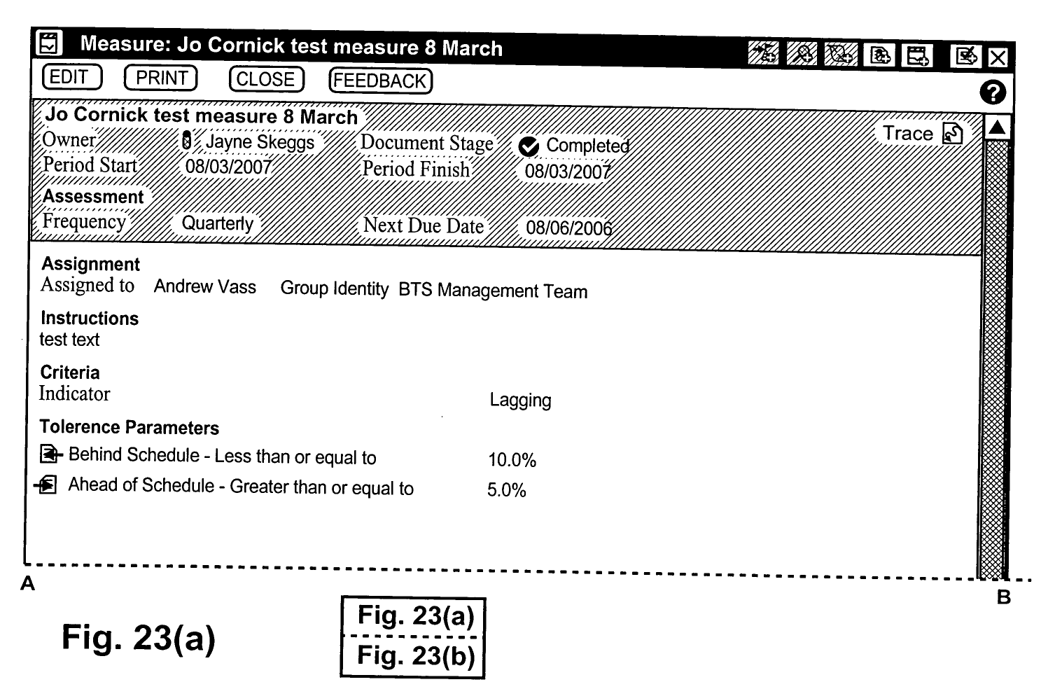

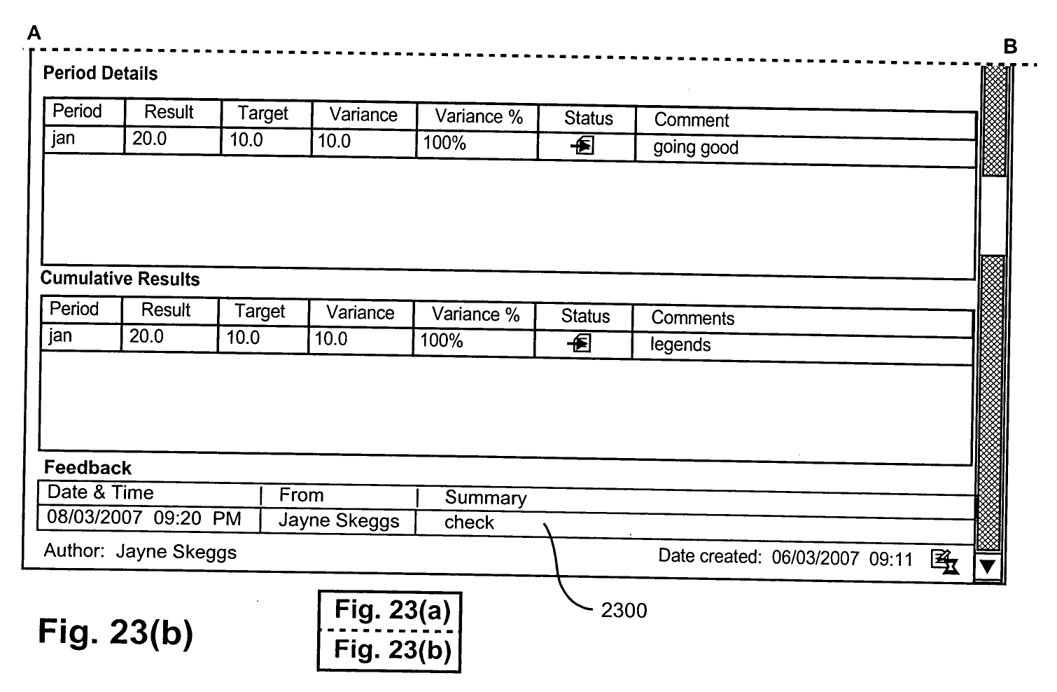

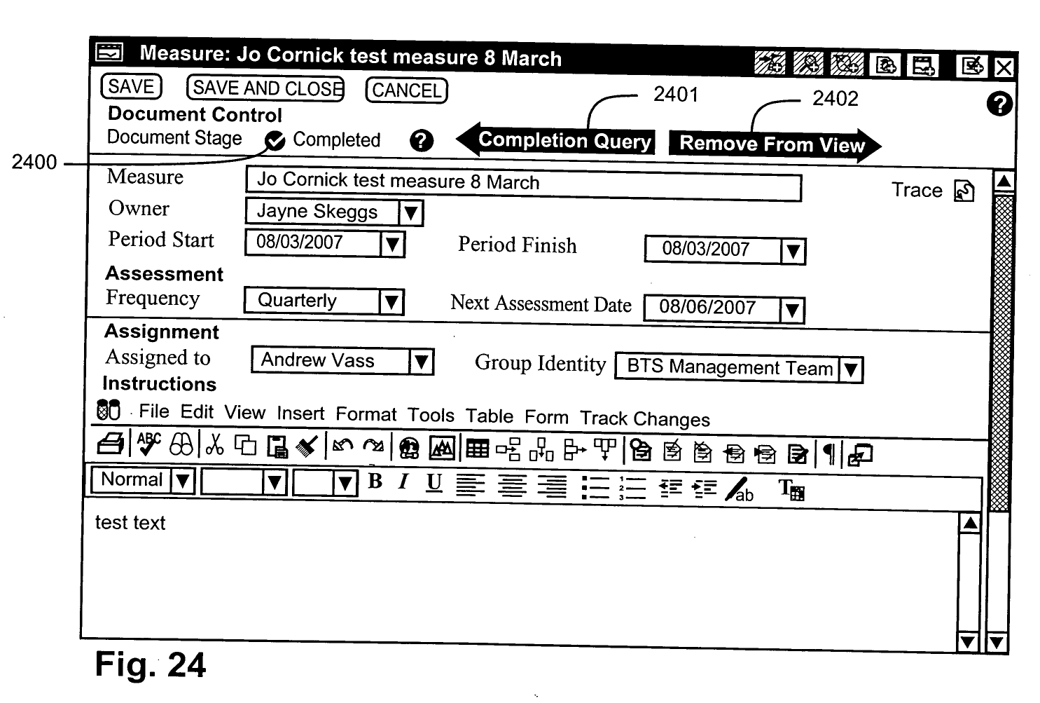

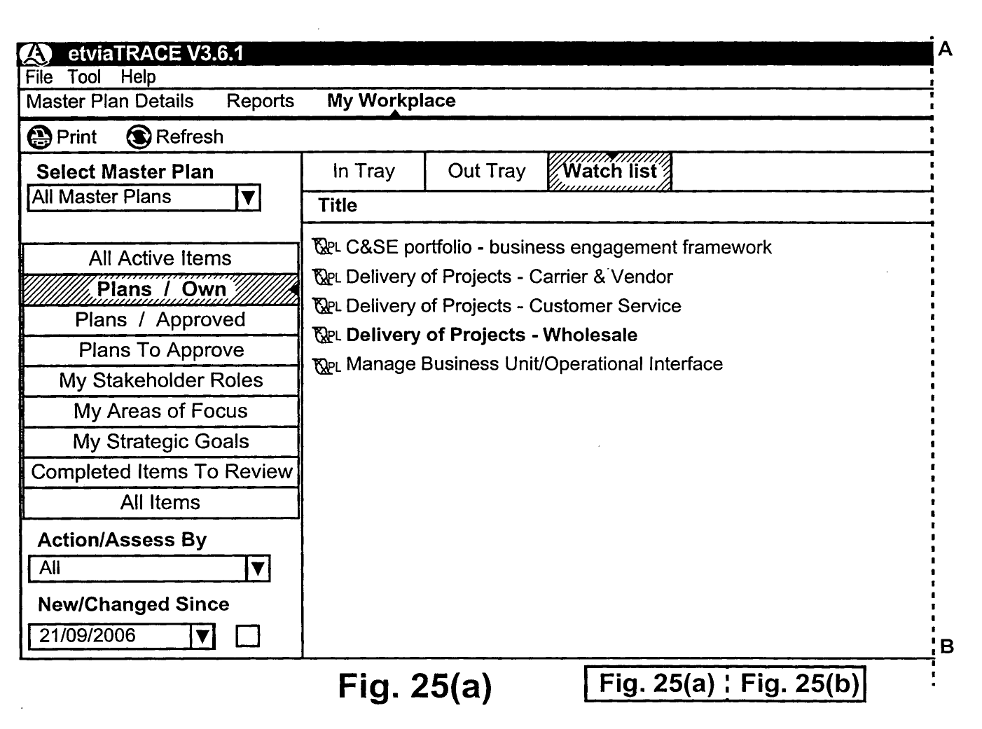

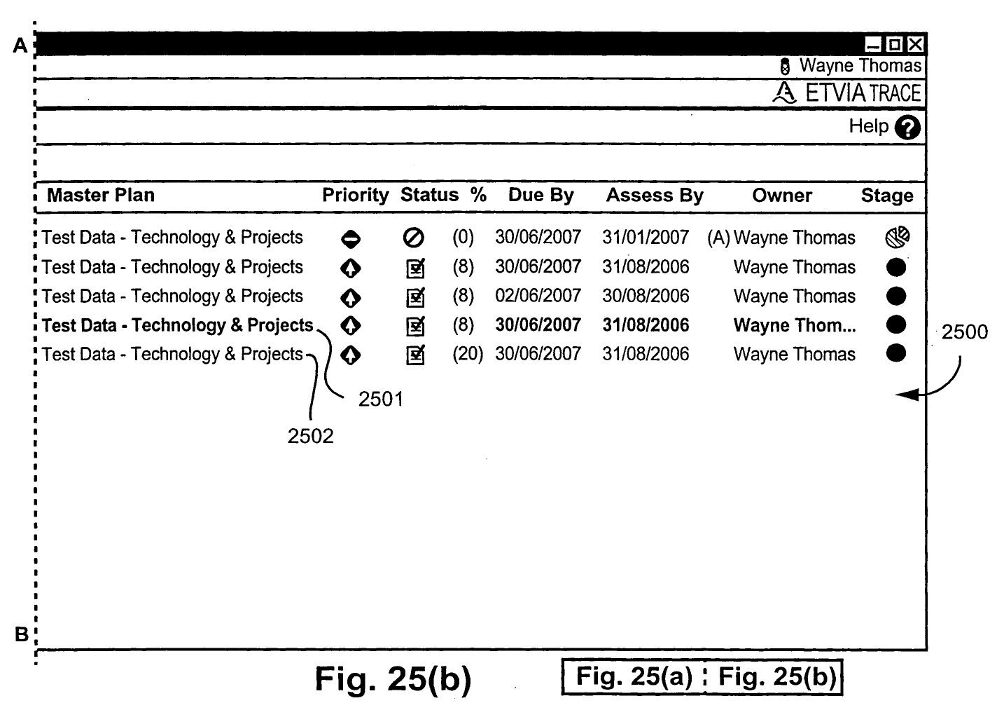

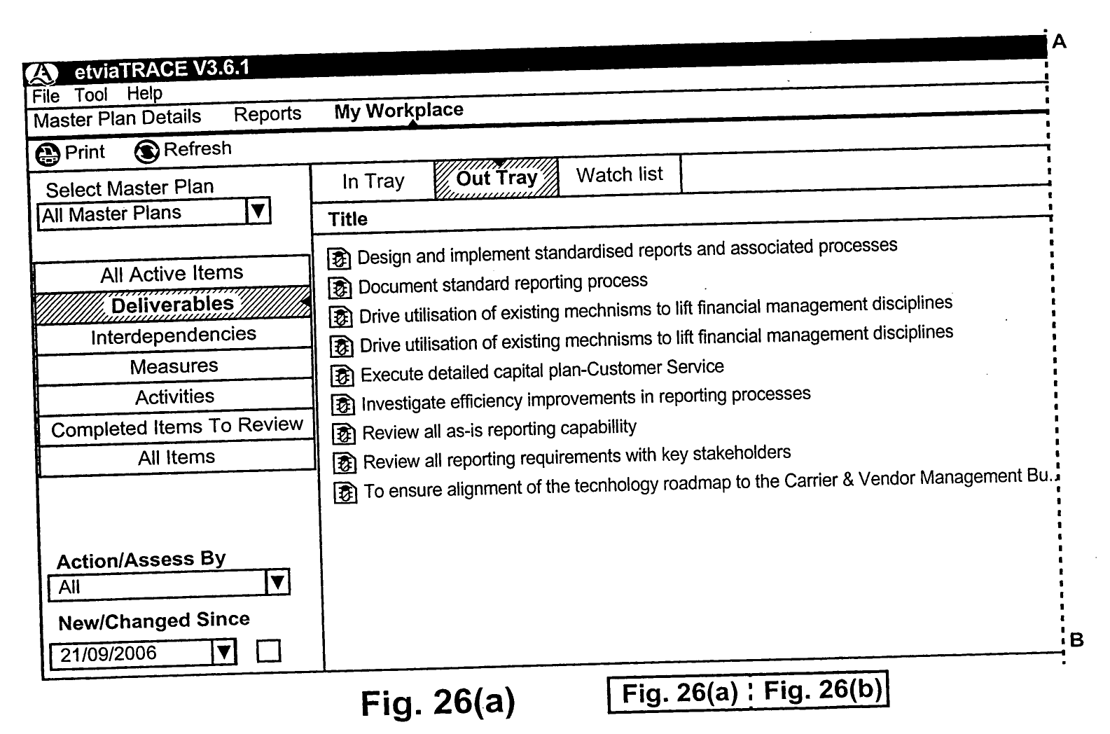

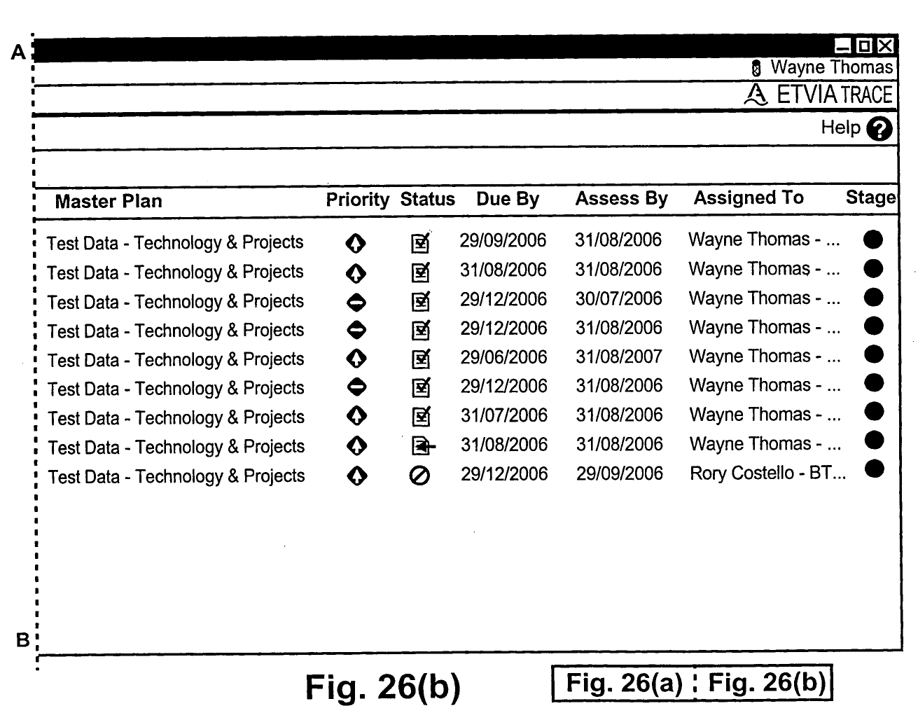

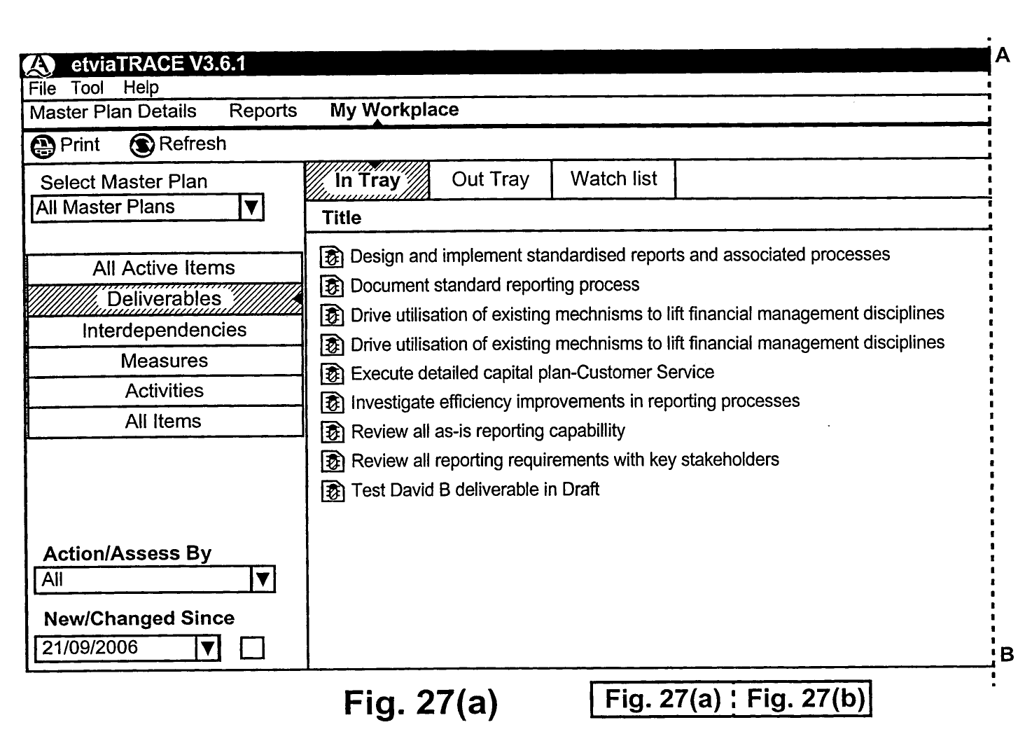

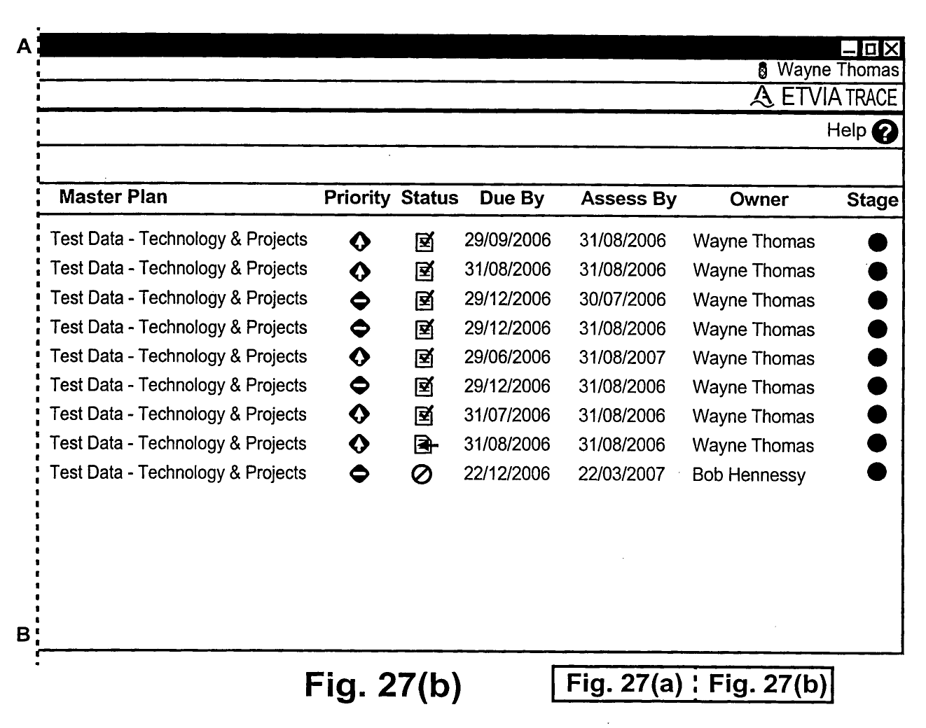

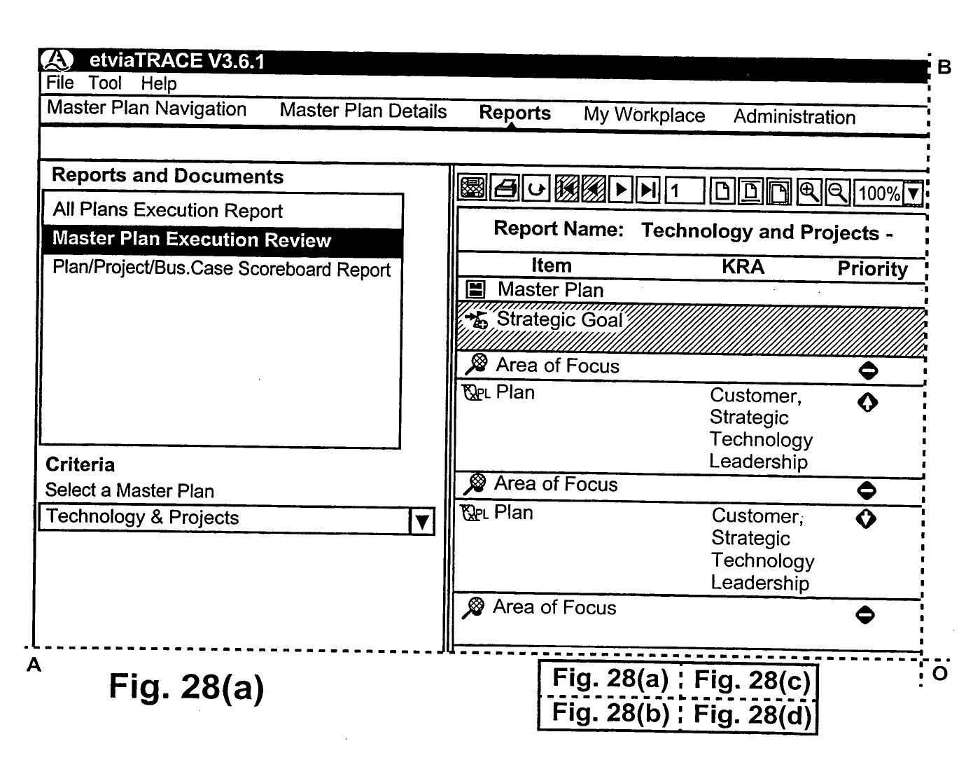

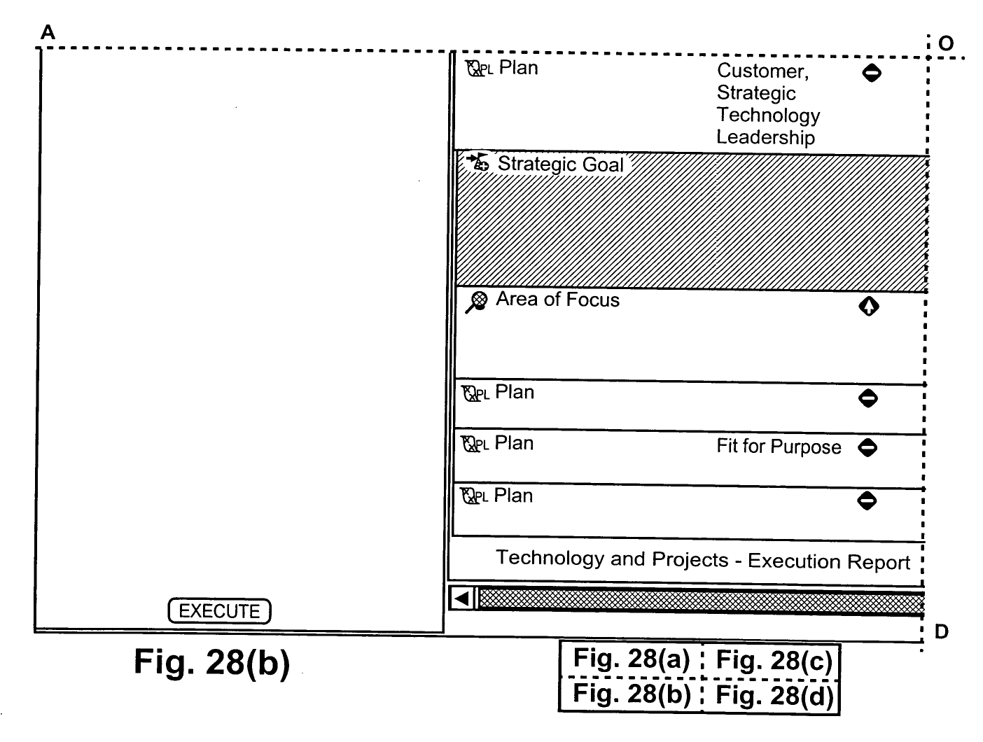

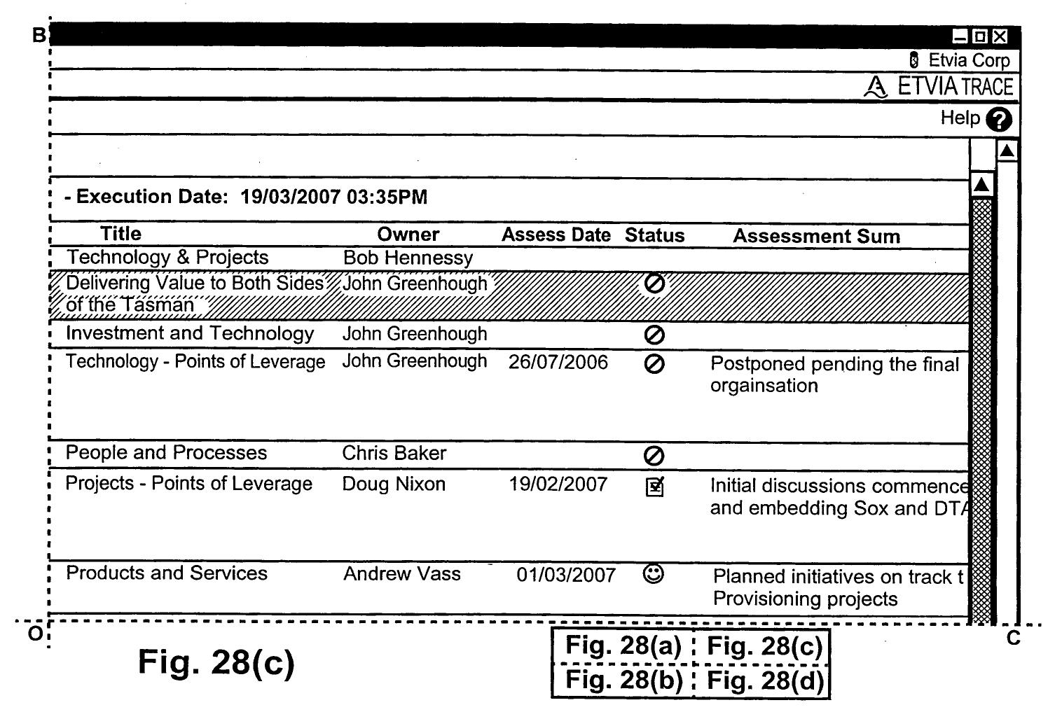

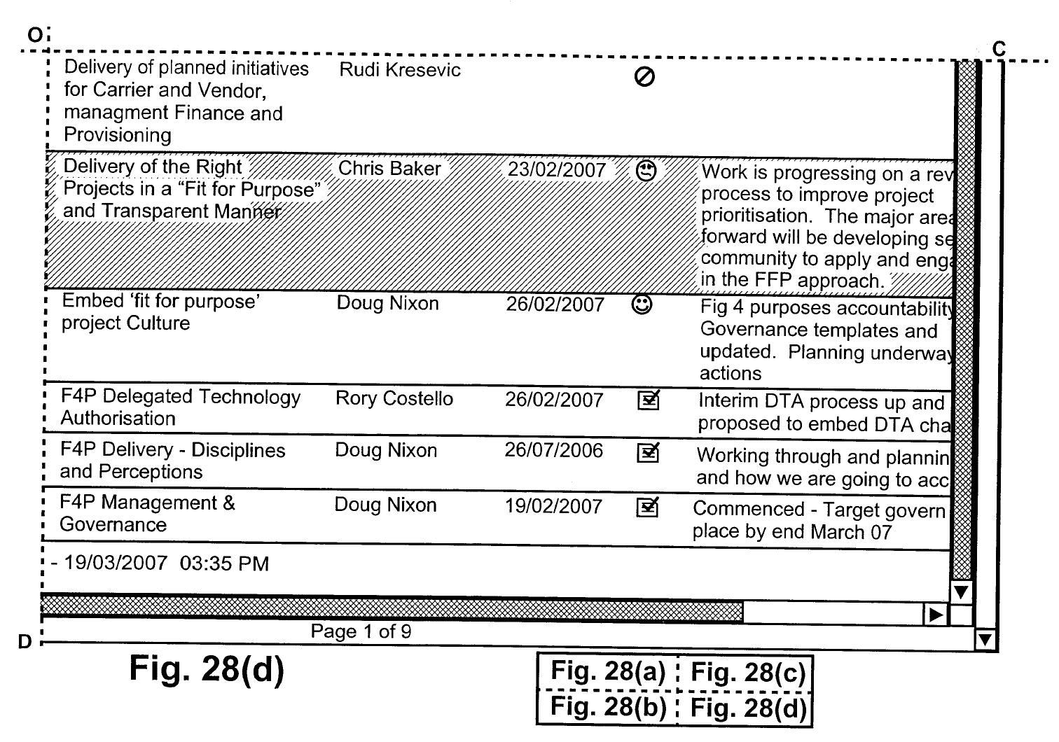

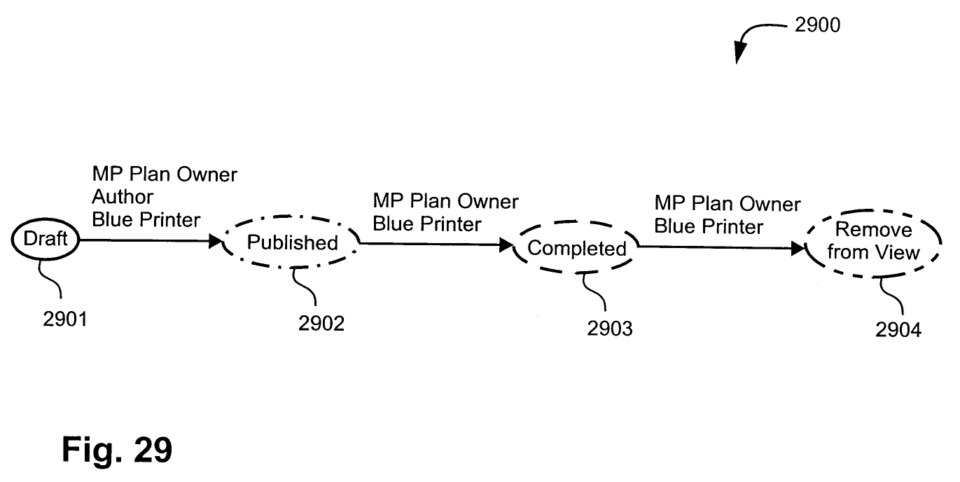

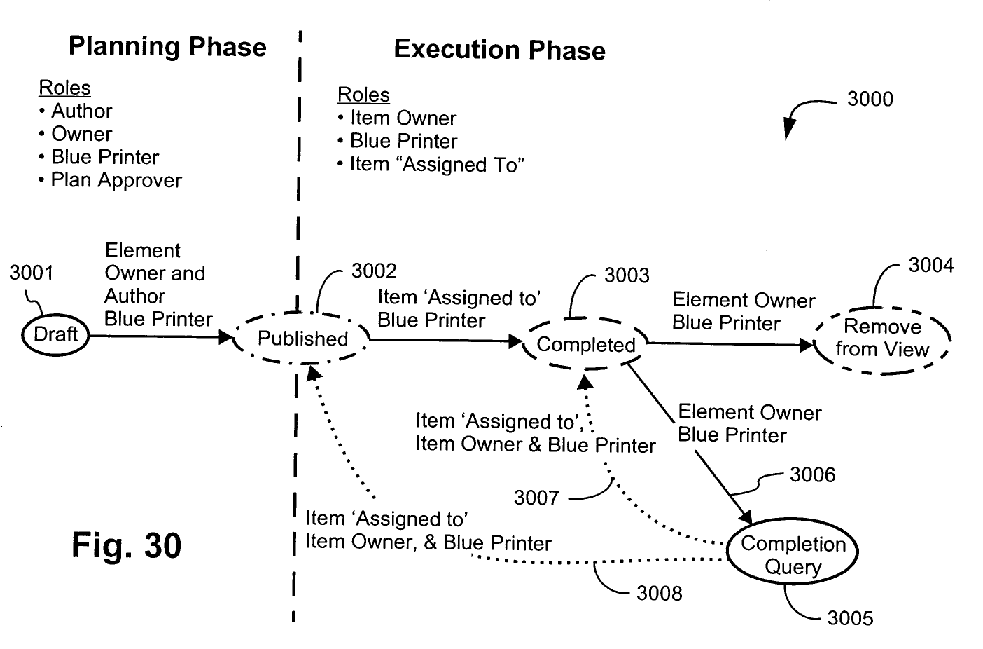

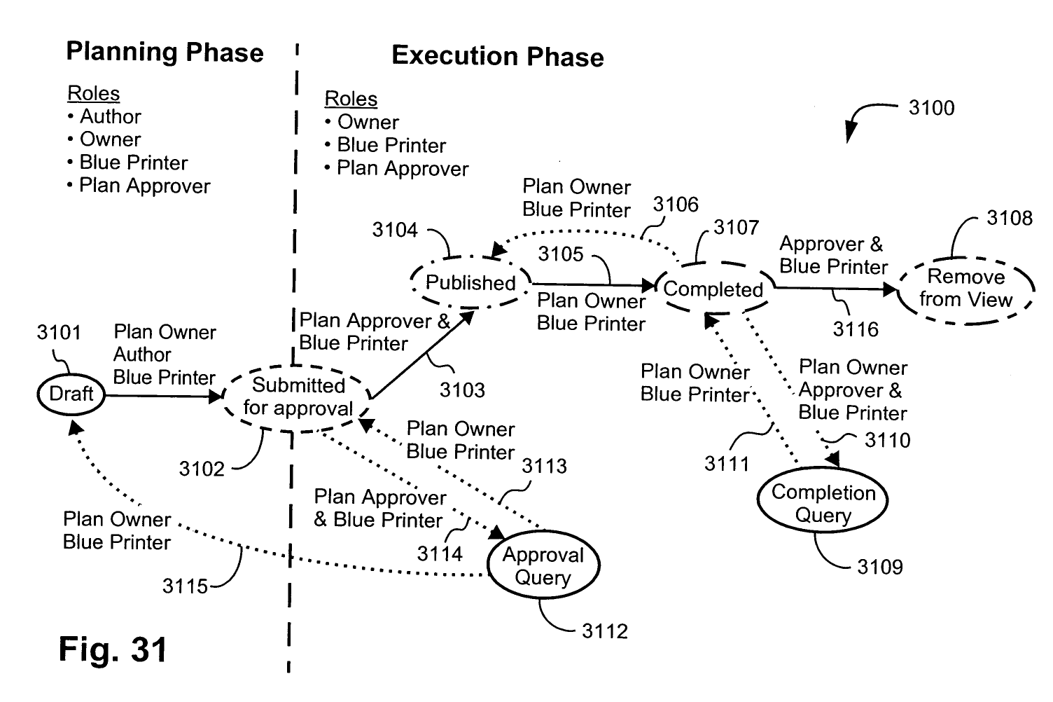

FIG. 1 shows a high level flowchart of how corporate strategy is formulated, information relating thereto is disseminated, and how the strategy is managed according to the disclosed distributed CPM arrangement. A process 200 commences with a step 201 in which corporate executives formulate the corporate strategy as a set of strategic goals extending across a number of financial periods. Either while this formulation is proceeding (according to a dashed arrow 203), or after the formulation is complete (according to an arrow 202), the strategy is disseminated (ie published) on a management platform by a step 204. This management platform can be implemented using a corporate-wide PC network as depicted in FIG. 9, and enables consistent live information to be available across the organisation. Strategy elements requiring an approval process are disseminated (ie published) on the management platform in a staged manner as described hereinafter in relation to FIG. 2.

In a following step 205, the disseminated strategy is managed by the various people in the corporation. An arrow 209 depicts how the distributed corporate performance management arrangement can be practiced throughout the organisation, enabling updating and revision of the strategy to be performed at any level of the organisation. An arrow 208 depicts how the corporate strategy that was formulated in the step 201 can also be updated at the corporate level.

An arrow 407 (see FIG. 5) flows from cascaded plans that are developed lower down in the organisation, and which are fed back into the strategy formulation and dissemination process via the step 204.

A dashed rectangle 210 depicts three features of the distributed CPM arrangements, namely an approval status transparency feature 211, a formulation status transparency feature 206, and a performance status transparency feature 207. These features enable the corporate strategy and its management to be transparent across the organisation. This transparency can, of course, be limited as desired by access controls according to the particular requirements of corporate officers.

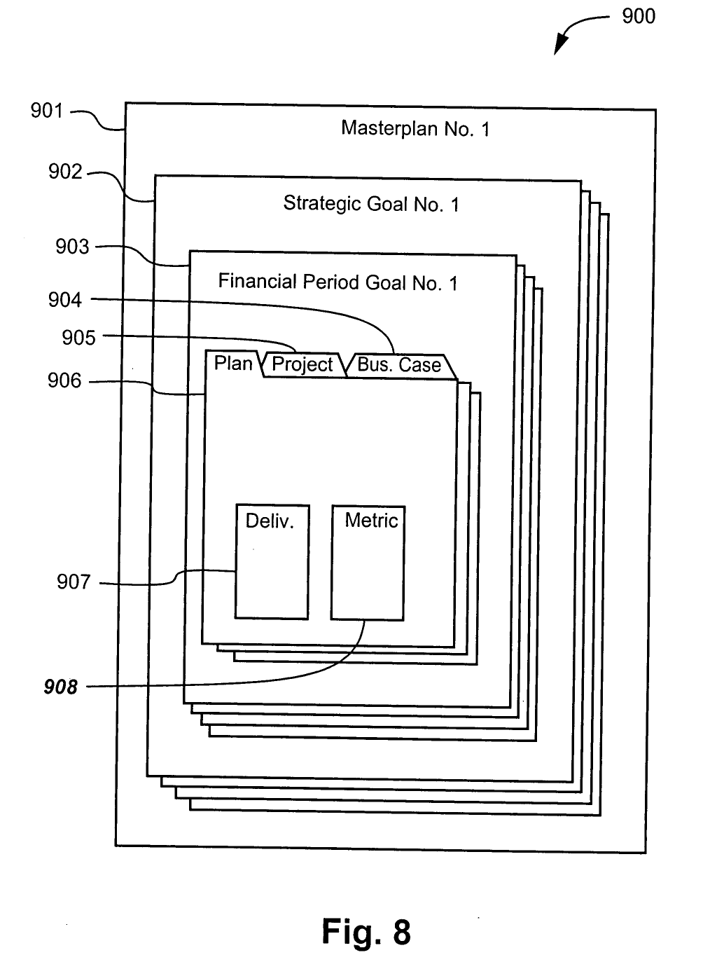

The disclosed distributed CPM arrangement thus provides a clear line of sight of the corporate strategy, from the top down, tracing the status of all strategy elements, and their interdependence upon other elements. The disclosed arrangements are particularly applicable to businesses using a matrix management approach having shared service inter-dependencies. According to the disclosed arrangements, in one integrated tool set the planning process is facilitated between all contributors to content development. Implementation is then facilitated via the visibility of accountabilities across the organisation, and status reports (see FIG. 8) that are inherent in the process of execution.

FIG. 2 depicts how strategy elements are approved, and approval status transparency is provided, as depicted by the approval transparency feature 211 in FIG. 1. This applies to strategy elements such as business cases which need to be approved and funded before they can be implemented. The process 211 commences with a step 801 in which, in the present example, the business case “proposer” develops a draft business case and presents it for approval to an “approver”, this being a person who has the decision making power to approve the business case.

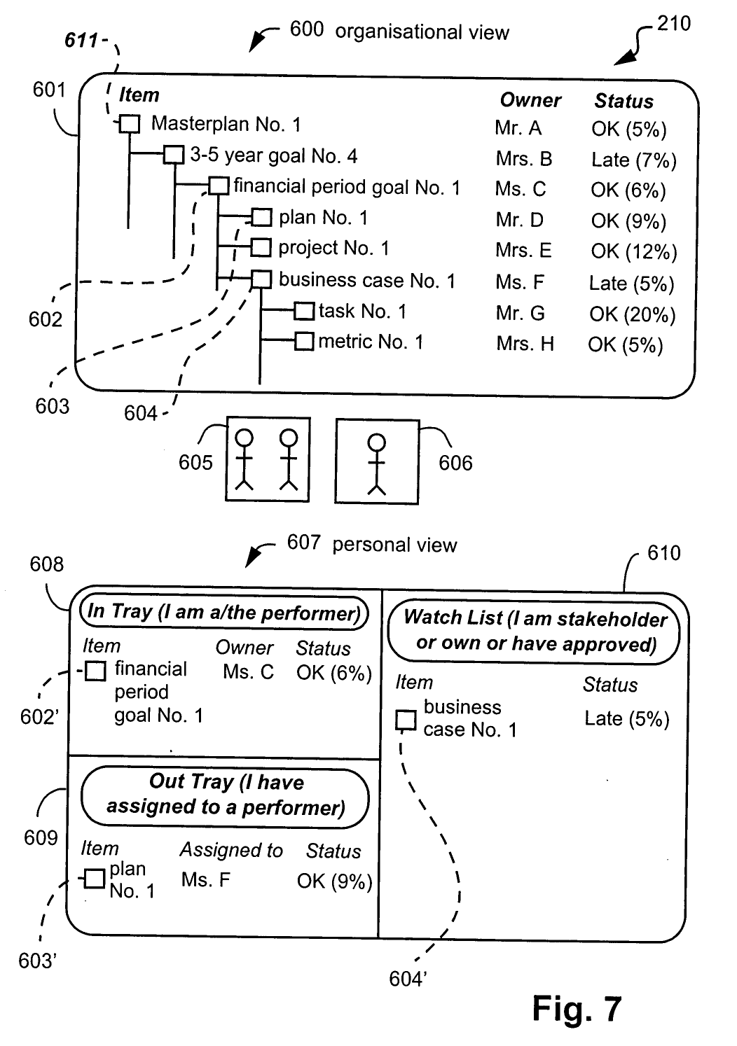

A subsequent step 802 depicts how the draft business case, which is not yet approved, is disseminated (published) in a limited manner on the management platform, and is made visible only to the proposer, the approver, and the key stakeholders associated with the business case. A graphical icon 806, in the form of a pie with shaded slices, can be presented in a Graphical User Interface (GUI) provided by the management platform in order to provide a simple and intuitive representation of the status of the approval process. Thus, as the approval process progresses, the number of shaded pie slices in the graphical icons shown at 806-810 increase correspondingly. These graphical icons can be incorporated into the GUIs described in relation to FIG. 7.

In a following step 803, the approver approves the draft business case, this being reflected by the graphical icons 807-809 which transition from being partially to fully-shaded. Thereafter, in a step 804, the proposer publishes the approved plan, after which in a step 805 the approved plan is made visible to everyone who has access to the corporate strategy over the management platform. A particular advantage of the disclosed distributed CPM arrangements is that the arrangements provide the ability to create the Business Plan (usually to support a fiscal period/budget) of the organisation as a subset or direct link to the strategic goals explicit in the strategic plan.

FIG. 3 shows the formulation status transparency feature 206 from FIG. 1 in more detail. This applies to deliverables which are discussed and negotiated between various parties, but which do not require approval as is the case with the business case described in relation to FIG. 2. The formulation status transparency process 206 comprises firstly a step 301 where a particular strategy element (ie deliverable) is proposed, discussed and negotiated between the various parties involved in the performance of that particular element. A following step 302 depicts how the proposed deliverable and the associated formulation status are published on the management platform, and thus become visible to everyone who is authorised to view the corporate strategy.

A graphical icon 605 shows two stick figures. This indicates, in the present example, that the proposed deliverable is still in the negotiation phase. The graphical icon 605 can be presented in the Graphical User Interface (GUI) provided by the management platform in order to provide a simple and intuitive representation of the status of the negotiation process. When the discussion and negotiation process is successfully completed in a subsequent step 303, the icon takes a form 606 having a single stick figure. These graphical icons 605 and 606 can be incorporated into the GUIs described in relation to FIG. 7. The step 303 represents conclusion, agreement and commitment to the negotiated deliverable.

From a strategy management and oversight perspective, it is important for members of the organisation to understand whether strategy elements, both of the business case variety which require an approval process, and of the deliverable variety which can be agreed between parties without requiring an approval process, have been committed to by the involved parties, or whether the parties are still negotiating details relating to performance of the strategy element. The clear visibility of this formulation and/or approval status is therefore an important element in the disclosed corporate performance management arrangements.

As will be described in more detail in relation to FIG. 7, the approval and/or formulation status is clearly depicted, in one example, in a graphical fashion, thereby providing an unambiguous view of the formulation status for any strategy element.

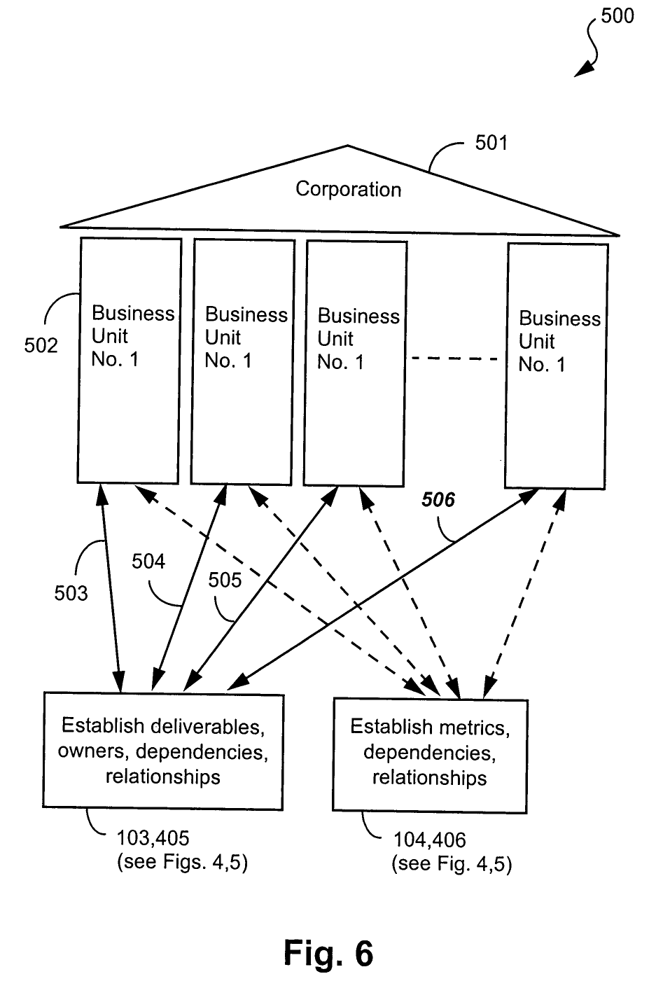

FIG. 4 shows a process flowchart of how the corporate strategy is formulated in the step 201 of FIG. 1. The process 201 commences with a step 100 in which corporate executives define strategic goals, these typically being goals to be achieved over a 3 to 5 year horizon and thus extending over a number of financial periods. These goals are referred to as 3-5 year strategic goals. In a following step 101, areas of focus flowing from the aforementioned 3-5 year strategic goals are determined. These areas of focus are typically priorities for the upcoming financial period, which are seen as the first necessary building blocks in achieving the aforementioned 3-5 year strategic goals. These areas of focus are also referred to as objectives or financial period goals.

In a following step 102, each financial period goal is resolved into defined plans, projects and business cases, these typically being needed for delivery of the financial period goals. A “plan” is a stream of work comprising of an objective, strategies, measures and deliverables (actionable tasks) that is owned and directed by a single person. A number of participants perform/execute the various deliverables in a plan. A plan typically encompasses work that revolves around the existing business, such as a plan to implement a particular marketing event, a plan to implement a leadership development program, or a plan to re-design a service delivery process. A plan is typically executed as part of the function of the business by a functional team such as marketing, Human Resources, or operations. However, the plan can involve collaboration by other areas of the business.

A “project” is a stream of work comprising an objective, strategies, measures and deliverables (actionable tasks) that is owned and directed by a single person. Multiple participants perform and/or execute the various deliverables. A project typically encompasses work that is “one-off”, having a defined scope, timeframe and resources. The project is often created to operate outside the functional design of the organization. Once the Project is delivered, the group or project team typically disbands. The project is therefore able to be tracked as a discrete centre of activity and resources, being isolated and clearly delineated from initiatives that are underway as part of the day-to-day execution of the organisation's plans.

A “business case” can be developed as either a plan or a project (as above). However, a Business Case needs to be approved and funded before it can be executed. The business case typically features in the strategy drafting phase. Once the plan is complete it is put forward for approval and funding. This may happen as part of a budget review process prior to the commencement of a financial year, for example. Alternately, the business plan can be used as a prioritisation process for the release of capital or contingency funds and savings as a financial period elapses.

Returning to FIG. 4, in a following step 103, for each plan/project/business case, it is necessary to establish which tasks must be done, who the assigned task owners are, and which (primary) dependencies and relationships are associated with the tasks. The term “dependencies” refers to the fact that any given task is dependent upon the completion, complete or partial, of other tasks, and may itself be a necessary precursor for the commencement of other tasks. These various linkages between tasks are referred to as dependencies. The term “relationships” refers not to other related tasks, but rather to the people involved in performing the task in question. These people can be “owners”, “performers”, “stake holders”, and so on.

An “owner” is a person who is ultimately responsible for successful completion of the task in question. A “performer” is a person who actually does the task in question, either by himself or with other people and resources. A “stake holder” is someone who has an interest in completion of the task, but is not an owner or a performer. Thus, for example, the head of finance may be a stake holder in a particular task if some of his or her staff are performers in relation to that task. The head of finance is neither an owner nor a performer, but clearly has an interest in performance of the task since his or her staff are involved in performance of the task.

A step 104, which is in parallel to the step 103, establishes, for each plan/project/business case, which metrics would be useful to monitor performance and measure success of the particular financial period goal. The term “metric” is used to define a way of measuring performance of something that is not easily described in terms of discrete milestones. Thus, for example, in order to build a building, it may be necessary to lay the foundations, erect the wooden frame, do the brickwork, erect the roof, install the internal cladding, do the plumbing, install the electrics, and do the final finishing. Each of the aforementioned items can be characterized as a milestone in a project sense which is either complete, or incomplete.

In contrast, the market share attained by a business is more easily measured in terms of a proportion of the total market that has been captured, this being a “continuous” rather than a “discrete” measure. Thus, the statement that “we have attained a 47.3% market share” is very useful as a measure in relation to the partial completion of such tasks.

FIG. 5 shows, in more detail, a flowchart of how the strategy management step 205 of FIG. 1 is applied to the deliverables and/or metrics, and how this is performed. The process 205 commences with a step 400 in which, for a particular task owner, the owner receives the particular tasks (such as a deliverable) which he owns. In a following step 401, the owner determines, for each owned task, whether the task is already sufficiently defined that it can be managed and/or performed in its present form, or whether it needs to be further refined. This refinement is performed, in the disclosed corporate performance management arrangement, by creating a further level of formulation and management.

If, for the task in question, the task is sufficiently well defined for direct management, then the process 205 follows a “MANAGE” arrow to a step 402. In the step 402, the task owner manages or produces the owned task (deliverable or metric) in question, and the process 205 loops back, according to an arrow 403, to the step 401. The aforementioned loop enables the task owner to continuously assess whether the task in question needs to be refined or whether it can be managed in its present form.

Returning to the step 401, if the task owner decides that the task needs to be refined, then the process 205 follows a “REFINE” arrow to a step 404. The step 404, together with a step 405 and a step 406 closely parallel corresponding steps 102, 103 and 104 in FIG. 4. However, whereas the steps 102, 103 and 104 in FIG. 4 are conducted at the “primary” formulation and management level depicted in FIG. 1, the steps 404, 405 and 406 are performed at any level down the strategy chain. This provides the disclosed corporate performance management arrangement with a distributed functionality which enables the corporate strategy and its constituent parts to be formulated, adapted and managed in a distributed fashion across the organisation.

Returning to the step 404, in FIG. 5, this means that the task owner in question defines, at his own particular level and location in the organisation, which plans, projects and business cases need to be formulated in order to deliver the particular task (which he owns) that is to be refined. In a following step 405 the task owner determines, for each of the aforementioned plans, projects and business cases defined in the step 404, which (sub) tasks must be done, who are the appropriate sub-task owners, which dependencies are associated with the (sub) tasks, and what the relationships are in performance of the (sub) tasks.

In a similar manner to that described in relation to the step 104, in FIG. 4, in the step 406, the task owner decides, for each plan, project and business case defined in the step 404, which metrics are required in order to monitor performance and measure success of the aforementioned plans, projects and business cases. The outcomes from the steps 405 and 406 flow, as depicted by the arrow 407, to the step 204 in FIG. 1. This enables the disclosed corporate performance management arrangement, as practiced by the task owner according to FIG. 5, to flow back into the corporation-wide management platform referred to in the step 204. This has the powerful effect of making the activities of the task owner in FIG. 5 visible across the corporation. This corporate-wide transparency (subject to the access controls earlier mentioned), provide the disclosed corporate performance management arrangements with the flexibility to operate across a corporation without being hindered by the organisation structure of the corporation. This is described in more detail in relation to FIG. 6.

The disclosed distributed CPM arrangement thus means that plans and sub-plans can be cascaded by way of deliverables or interdependencies, whereby the person charged with the responsibility for execution has the ability to create a plan for the execution of the deliverable. This “cascade mechanism” can commence with a plan having a series of deliverables. Each deliverable can then be used as the basis for creating another plan to manage its execution. Thereby, the cascade can go from a deliverable in a plan, to a plan being created with deliverables in that plan, that will also have deliverables from which a further plan can be created.

FIG. 6 depicts a particular corporation and the business units associated therewith, as they interact with the disclosed corporate performance management arrangement. A corporation 501 is seen to have business units 1-n each being depicted as a free-standing business unit. This structure is very common in modern day companies. The block 103, 405 depicts the corresponding process steps in FIG. 4 and FIG. 5 respectively. Having regard to FIG. 4, since the process 201 is typically performed by the corporate executives, as shown in FIG. 1, it is a relatively easy task for those executives to operate across business units 1-n as depicted by arrows 503-506. It is important to note, however, that according to the disclosed corporate performance management arrangements, the task owner referred to in relation to FIG. 5, can operate across the aforementioned business units in the same way.

Thus, for example, an engineering manager (whose organisational role places him in business unit no. 2) who is the task owner somewhere down the strategy chain as depicted in FIG. 5 can, as depicted by the arrow 503, contact the catering manager (whose organisational role places him in the business unit no. 1) in regard to the deliverable to be refined. Provided that the engineering manager (i.e., the task owner) is able to persuade the catering manager to agree and commit to perform a particular task associated with the deliverable to be refined, this task can be incorporated into the corporate strategy using the processes described in FIGS. 1-5. This is notwithstanding the fact that the engineering manager may be many levels “down” in the corporation in question, and would not in normal circumstances be able to create a cascaded project segment on his own authority. This is a powerful advantage of the disclosed corporate performance management arrangement.

FIG. 7 depicts two graphical user interfaces 600 and 607 that can be used to implement the facilitation function 210 in FIG. 1. These GUIs enable the corporate strategy and associated strategy elements to be viewed by how they relate to organisational objectives (see 600 in FIG. 7), as well as how they are assigned and delineated according to the organisational design and structure (see 607 in FIG. 7). The graphical user interface (GUI) 600 is typically presented in the form of a window 601 on a video display 714 (see FIG. 9) of the corporation-wide management platform. Within the window 601, headings for three columns can be seen at the top of the window, these headings being “item”, “owner”, and “status”. In the “item” column, a hierarchical arrangement (also referred to as a strategy chain) is depicted, in which master plan no. 1 has a number of 3-5 year goals, one of which being 3-5 year goal no. 4 is shown. This 3-5 year goal no. 4 has a number of financial period goals, one of which, being financial period goal no. 1 is shown. The financial period goal no. 1 has a number of elements, the elements shown in FIG. 7 being plan no. 1, project no. 1, and business case no. 1. Each of the aforementioned plan, project and business case is associated with tasks and/or metrics, and as a specific case, business case no. 1 is shown to have at least task no. 1 and metric no. 1.

The information shown in the window 601 thus clearly shows the constituent elements of strategic 3-5 year goals, in the current or upcoming financial period, in the form of a number of financial period goals. Each of these financial period goals is achieved according to plans and/or projects and/or business cases. The aforementioned plans, projects and business cases are themselves each achieved by performing associated constituent tasks and/or metrics.

Each of the elements shown in the window 601 has an associated icon, and accordingly, for example, the financial period goal no. 1 has an associated icon depicted as a square 602. Similarly, the plan no. 1 has an associated icon 603, and the business case no. 1 has an associated icon 604. Each of the aforementioned icons 602-604 provide, in the example shown, the formulation status transparency referred to at 206 in FIG. 1. Accordingly, the icon 602 can, for example, take the form shown at 605 that has, as described in relation to FIG. 3, two stick figures of people encompassed in a square frame. This depicts that the financial period goal no. 1 is still at the propose/discuss/negotiatc stage depicted by the step 301 in FIG. 3. In contrast, the icon 603 can, for example, have the form shown at 606, which has a single stick figure representation in a square frame as described in relation to FIG. 3. This would mean that plan no. 1 is at the agree/commit stage, as depicted by the step 302 in FIG. 3.

The window 601 also shows, under the heading “status”, the status of the various strategy elements. Also shown, under the heading “owner”, are the owners of the various strategy elements. Thus, for example, having regard to the top level master plan no. 1, the window 601 shows that the master plan. no. 1 is owned by a Mr A, and that the status is “OK” and is at the 5% completion level. This status information provides the performance status transparency referred to at 207 in FIG. 1. Furthermore, if the icon 611 associated with the master plan no. 1 is of the form shown at 605, then this would mean that in terms of formulation status, the master plan no. 1 is still at the propose/discuss/negotiate stage as shown at 301 in FIG. 3.

The GUI 600 presents an organisation view across the corporation 501 (see FIG. 6) and provides one important perspective of how the master plan no. 1 is progressing.

The GUI 607 is implemented using another window in the video display 714 in FIG. 9. The GUI 607 is a personal view that is provided to any person involved in the strategy associated with the master plan no. 1. The GUI 607 comprises three sub-windows, these being 608, 609 and 610. The window 608 is referred to as an “in tray”.

The GUI 600 is a view of the corporate strategy that is independent of the person who is viewing the GUI 600. In contrast, the GUI 607 shows a view that is dependent upon the person who is looking at it. The in tray shows items for which the viewer is the performer. Thus, in the GUI 607, an icon 602′ indicates that the viewer is the performer who is to complete the task referred to as the financial period goal no. 1.

Accordingly, the viewer of the GUI 607 is the performer of the elements in the window 608. The viewer has assigned the elements in the window 609 to (other) performers and the viewer is a stakeholder, or owns, or has approved elements in the window 610.

Returning to the window 608, the viewer is the performer relating to the financial period goal no. 1. The owner of the financial period goal no. 1 is Ms. C, and the status of this item is “OK”, and the item is 6% completed. According to the disclosed corporate performance management arrangements, the viewer does not have the power to refine the financial period goal no. 1 (according to the process 401 in FIG. 5), but instead has been assigned a task to perform which could be actioning a deliverable, updating a measure, assessing progress or so on in relation to the financial period goal no. 1. In contrast, Ms. C who is the owner of this particular item could refine the item if she so elected.

The out tray in the window 609 shows the viewer everything that the viewer has assigned to others to perform. Thus, the plan no. 1, as depicted by the icon 603′, has been assigned by the viewer to Ms. F. The window 610 presents to the viewer all items that the viewer either owns, has approved, or has an interest in. As described in relation to FIG. 2, the approval status of items in the GUIs can be depicted by the graphical icons 806-810. What the disclosed distributed CPM arrangements achieve is to enable the user to not only see the plan, but to see all the relationships within it for execution in a multi-dimensional way. Accordingly, the user can see upstream and down stream of the initiative they have been assigned, including the full context as to why they have been included and the contribution their task will make in the overall achievement of the organisation's objectives.

In this regard, a “trace” function is available, enabling a task owner, such as Ms. C who is the performer of the financial period goal No. 1 (ie 602′) to select the element 602′, and to automatically determine and generate an organisational view representation of the element 602′. This would show Ms. C how the element 602′ fits into the overall strategy, including all upstream elements depending upon 602′ and all dependencies.

FIG. 8 depicts how the disclosed distributed CPM arrangements generate and produce associated reports and documentation. These documents can be output, typically on demand, whenever they are requested. Each process step in the disclosed distributed CPM arrangements, such as the steps 801-805 in FIG. 2, the steps 301-303 in FIG. 3, the steps 100-104 in FIG. 4, and the steps 400 to 406 in FIG. 5 are associated with production of documents and reports. The reports typically comprise forms with certain predefined prescriptive fields, and further have areas of free text, notes, and can support attachment of other documents and multimedia information. These documents and reports are automatically produced during the course of performing the aforementioned processes, and form an integrated documentation set depicted in FIG. 8.

This documentation set is shown for a particular master plan 901 that comprises a set of strategic goals such as 902. Each such strategic goal 902 comprises a set of financial period goals such as 903. Each such financial period goal 903 comprises a set of plans such as 906, a set of projects such as 905, and a set of business cases such as 904. Each such plan 906 comprises a set of deliverables such as 907 and a set of metrics such as 908.

Status reports regarding plan execution status is thus made available on the down stream status off all supporting initiatives and hence an independent view is possible. The audience for such a report is thus information enabled, and is thus capable of seeing for themselves with complete transparency the details that would support an overall evaluation. This also supports a governance model for planning and execution management.

FIG. 9 is a schematic block diagram of a general-purpose computer system, upon which the disclosed distributed CPM arrangements can be practiced. The method of distributed CPM may be implemented using a computer system 700, such as that shown in FIG. 9 wherein the processes of FIGS. 1-5 may be implemented as software, such as one or more distributed CPM application programs executable within the computer system 700. The computer system 700 typically comprises a significant number of interconnected computer modules such as 701 and 725, upon which the distributed CPM software modules run. In particular, the steps of method of distributed CPM are effected by instructions in the software that are carried out within the computer system 700. The instructions may be formed as one or more code modules, each for performing one or more particular tasks.

The software may also be divided into two separate parts, in which a first part and the corresponding code modules performs the distributed methods and a second part and the corresponding code modules manage a user interface between the first part and the user such as the GUIs described in relation to FIGS. 2, 3 and 7. The software may be stored in a computer readable medium, including the storage devices described below, for example. The software is loaded into the computer system 700 from the computer readable medium, and then executed by the computer system 700. A computer readable medium having such software or computer program recorded on it is a computer program product. The use of the computer program product in the computer system 700 preferably effects an advantageous apparatus for performing the disclosed distributed CPM arrangements.

As seen in FIG. 9, the computer system 700 is formed by a computer module 701, input devices such as a keyboard 702 and a mouse pointer device 703, and output devices including a printer 715, a display device 714 and loudspeakers 717. An external Modulator-Demodulator (Modem) transceiver device 716 may be used by the computer module 701 for communicating to and from a communications network 720 via a connection 721. The network 720 may be a wide-area network (WAN), such as the Internet or a private WAN. Where the connection 721 is a telephone line, the modem 716 may be a traditional “dial-up” modem. Alternatively, where the connection 721 is a high capacity (eg: cable) connection, the modem 716 may be a broadband modem. A wireless modem may also be used for wireless connection to the network 720.

The computer module 701 typically includes at least one processor unit 705, and a memory unit 706 for example formed from semiconductor random access memory (RAM) and read only memory (ROM). The module 701 also includes an number of input/output (I/O) interfaces including an audio-video interface 707 that couples to the video display 714 and loudspeakers 717, an I/O interface 713 for the keyboard 702 and mouse 703 and optionally a joystick (not illustrated), and an interface 708 for the external modem 716 and printer 715. In some implementations, the modem 716 may be incorporated within the computer module 701, for example within the interface 708. The computer module 701 also has a local network interface 711 which, via a connection 723, permits coupling of the computer system 700 to a local computer network 722, known as a Local Area Network (LAN). As also illustrated, the local network 722 may also couple to the wide network 720 via a connection 724, which would typically include a so-called “firewall” device or similar functionality. The interface 711 may be formed by an Ethernet™ circuit card, a wireless Bluetooth™ or an IEEE 802.21 wireless arrangement.

The interfaces 708 and 713 may afford both serial and parallel connectivity, the former typically being implemented according to the Universal Serial Bus (USB) standards and having corresponding USB connectors (not illustrated). Storage devices 709 are provided and typically include a hard disk drive (HDD) 710. Other devices such as a floppy disk drive and a magnetic tape drive (not illustrated) may also be used. An optical disk drive 712 is typically provided to act as a non-volatile source of data. Portable memory devices, such optical disks (eg: CD-ROM, DVD), USB-RAM, and floppy disks for example may then be used as appropriate sources of data to the system 700.

The components 705, to 713 of the computer module 701 typically communicate via an interconnected bus 704 and in a manner which results in a conventional mode of operation of the computer system 700 known to those in the relevant art. Examples of computers on which the described arrangements can be practised include IBM-PC's and compatibles, Sun Sparcstations, Apple Mac™ or alike computer systems evolved therefrom.

Typically, the distributed CPM application programs discussed above are resident on the hard disk drive 710 and are read and controlled in execution by the processor 705. Intermediate storage of such programs and any data fetched from the networks 720 and 722 may be accomplished using the semiconductor memory 706, possibly in concert with the hard disk drive 710. In some instances, the application programs may be supplied to the user encoded on one or more CD-ROM and read via the corresponding drive 712, or alternatively may be read by the user from the networks 720 or 722. Still further, the software can also be loaded into the computer system 700 from other computer readable media. Computer readable media refers to any storage medium that participates in providing instructions and/or data to the computer system 700 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 701. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display 714. Through manipulation of the keyboard 702 and the mouse 703, a user of the computer system 700 and the application may manipulate the interface to provide controlling commands and/or input to the applications associated with the GUI(s).

### INDUSTRIAL APPLICABILITY

It is apparent from the above that the arrangements described are applicable to the computer and data processing industries.

The foregoing describes only some embodiments of the present invention, and modifications and/or changes can be made thereto without departing from the scope and spirit of the invention, the embodiments being illustrative and not restrictive.

(Australia Only) In the context of this specification, the word “comprising” means “including principally but not necessarily solely” or “having” or “including”, and not “consisting only of”. Variations of the word “comprising”, such as “comprise” and “comprises” have correspondingly varied meanings.

The claims defining the invention are as follows:

1. A method of formulating and managing a strategy for an organisation, the method comprising the steps of:
(a) formulating strategic goals, extending across a plurality of financial periods, for the organisation;
(b) determining objectives for an upcoming financial period, said objectives being required for achieving that part of the goals associated with the upcoming financial period;
(c) resolving each objective into at least one of discrete deliverables and continuous metrics, wherein:
(ca) a performance status of a discrete deliverable can be characterised by being one of completed and not completed; and
(cb) a performance status of a continuous metric can be characterised by being partially completed;
(d) assigning an owner to each said discrete deliverable and continuous metric;
(e) disseminating information about (i) the strategic goals, (ii) the objectives, (iii) the discrete deliverables and their associated performance status, and (iv) the continuous metrics and their associated performance status across the organisation; and, in regard to each said discrete deliverable and continuous metric, performing one of:
(ea) producing, under control of the corresponding owner, said discrete deliverable and said continuous metric; and
(eb) applying, by said corresponding owner, the resolving, assigning and disseminating steps to said discrete deliverable or a said continuous metric.

2. A method according to claim 1, wherein the disseminating step comprising a further step of:
disseminating information about formulation status of the discrete deliverables and the continuous metrics wherein:
a formulation status of a discrete deliverable can be characterised by being one of in negotiation and agreed; and
a formulation status of a continuous metric can be characterised by being one of in negotiation and agreed.

3. A method according to claim 1, wherein the disseminating step comprising a further step of:
disseminating information about approval status of a strategy element, wherein said approval status can be characterised by being one of not yet approved, and approved.

4. A method according to claim 3, wherein the step of disseminating information about the approval status comprises the steps of:
disseminating the information, if the approval status is not yet approved, only to the proposer, the approver, and to stakeholders associated with the strategy element; and
disseminating the information, if the approval status is approved, without limiting said dissemination only to the proposer, the approver, and to stakeholders associated with the strategy element.

5. A method according to claim 1, wherein at least some of the steps (a) to (e) further comprises the steps of:
generating documentation describing the corresponding step; and
outputting, dependent upon a request, said documentation.

6. A method according to claim 1 comprising the further steps of:
selecting one of the strategic goals, the objectives, the discrete deliverables, and the continuous metrics, said strategic goals, objectives, discrete deliverables, and continuous metrics being referred to as strategy elements; and
determining, for the selected strategy element, all upstream strategy elements upon which the selected strategy element is dependent.

7. A method according to claim 2, wherein the disseminating step comprises the steps of:
presenting the information using at least one of an organisation view GUI and a personal view GUI.

8. An apparatus for formulating and managing a strategy for an organisation, said apparatus comprising:
a memory for storing a program; and
a processor for executing the program, said program comprising:
(a) code for formulating strategic goals, extending across a plurality of financial periods, for the organisation;
(b) code for determining objectives for an upcoming financial period, said objectives being required for achieving that part of the goals associated with the upcoming financial period;
(c) code for resolving each objective into at least one of discrete deliverables and continuous metrics, wherein:
(ca) a performance status of a discrete deliverable can be characterised by being one of completed and not completed; and
(cb) a performance status of a continuous metric can be characterised by being partially completed;
(d) code for assigning an owner to each said discrete deliverable and continuous metric;
(e) code for disseminating information about (i) the strategic goals, (ii) the objectives, (iii) the discrete deliverables and their associated performance status, and (iv) the continuous metrics and their associated performance status across the organisation; and, in regard to each said discrete deliverable and continuous metric, performing one of:
(ea) producing, under control of the corresponding owner, said discrete deliverable and said continuous metric; and
(eb) applying, by said corresponding owner, the resolving, assigning and disseminating steps to said discrete deliverable or a said continuous metric.

9. A computer program product having a computer readable medium having a computer program recorded therein for formulating and managing a strategy for an organisation, said computer program product comprising:
(a) code for formulating strategic goals, extending across a plurality of financial periods, for the organisation;
(b) code for determining objectives for an upcoming financial period, said objectives being required for achieving that part of the goals associated with the upcoming financial period;
(c) code for resolving each objective into at least one of discrete deliverables and continuous metrics, wherein:
(ca) a performance status of a discrete deliverable can be characterised by being one of completed and not completed; and
(cb) a performance status of a continuous metric can be characterised by being partially completed;
(d) code for assigning an owner to each said discrete deliverable and continuous metric;
(e) code for disseminating information about (i) the strategic goals, (ii) the objectives, (iii) the discrete deliverables and their associated performance status, and (iv) the continuous metrics and their associated performance status across the organisation; and, in regard to each said discrete deliverable and continuous metric, performing one of:
(ea) producing, under control of the corresponding owner, said discrete deliverable and said continuous metric; and
(eb) applying, by said corresponding owner, the resolving, assigning and disseminating steps to said discrete deliverable or a said continuous metric.

10. A method of formulating and managing a strategy for an organisation, substantially as described herein, with reference to the accompanying drawings.

11. An apparatus for formulating and managing a strategy for an organisation, substantially as described herein, with reference to the accompanying drawings.

12. A computer program product, substantially as described herein, with reference to the accompanying drawings.
